(19) United States
(12) Patent Application Publication
(10) Pub. No.: US 2026/0134012 A1
(43) Pub. Date: May 14, 2026

(54) ELECTRONIC DEVICE, METHOD, AND NON-TRANSITORY COMPUTER-READABLE STORAGE MEDIUM FOR GENERATING INPUT DATA BASED ON OUTPUT DATA

(71) Applicant: Samsung Electronics Co., Ltd., Suwon-si (KR)

(72) Inventors: Taegu KIM, Suwon-si (KR); Inchul HWANG, Suwon-si (KR); Hanjun LEE, Suwon-si (KR); Jimin LEE, Suwon-si (KR)

(21) Appl. No.: 19/441,086

(22) Filed: Jan. 6, 2026

Related U.S. Application Data
(63) Continuation of application No. PCT/KR2025/009566, filed on Jul. 3, 2025.

(30) Foreign Application Priority Data
Jul. 5, 2024 (KR) 10-2024-0089297
Jul. 9, 2024 (KR) 10-2024-0090771
Sep. 6, 2024 (KR) 10-2024-0121944

(51) Int. Cl. G06F 16/3329; G06F 9/451

(52) U.S. Cl. CPC G06F 16/33295; G06F 9/451

(57) ABSTRACT

According to an embodiment, a method performed by an electronic device may include, based on a language-based user input, identifying first input data including first intent related to a first domain, and second input data including second intent related to a second domain, obtaining, based on inputting the first input data to an application, first response data related to the first intent, generating, based on the first response data and the second input data, third input data, obtaining, based on inputting the third input data to the application, second response data related to the second intent, and providing, based on the second response data, a service on the second domain, associated with a service on the first domain.

### CROSS-REFERENCE TO RELATED APPLICATION(S)

This application is a continuation application, claiming priority under 35 U.S.C. § 365(c), of an International application No. PCT/KR2025/009566, filed on Jul. 3, 2025, which is based on and claims the benefit of a Korean patent application number 10-2024-0089297, filed on Jul. 5, 2024, in the Korean Intellectual Property Office, of a Korean patent application number 10-2024-0090771, filed on Jul. 9, 2024, in the Korean Intellectual Property Office, and of a Korean patent application number 10-2024-0121944, filed on Sep. 6, 2024, in the Korean Intellectual Property Office, the disclosure of each of which is incorporated by reference herein in its entirety.

### TECHNICAL FIELD

The disclosure relates to an electronic device, a method, and non-transitory computer-readable storage media for generating input data based on output data.

### BACKGROUND ART

Electronic devices may provide a service to perform a certain function in response to a user's request, using a conversational application. The electronic devices may identify a voice input from a user and perform a function in response to the voice input. The electronic devices may use an artificial intelligence model to identify a function requested by the user based on the voice input. The electronic devices may perform the function requested by the user.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Solution

Aspects of the disclosure are to address at least the above-mentioned problems and/or disadvantages and to provide at least the advantages described below. Accordingly, an aspect of the disclosure is to provide an electronic device, a method, and non-transitory computer-readable storage media for generating input data based on output data.

Additional aspects will be set forth in part in the description which follows and, in part, will be apparent from the description, or may be learned by practice of the presented embodiments.

According to an embodiment, an electronic device may include memory including one or more storage media, storing instructions, and at least one processor comprising processing circuitry. The instructions, when executed by the at least one processor individually or collectively, may cause the electronic device to: based on a language-based user input, identify first input data including first intent related to a first domain and second input data including second intent related to a second domain; input the first input data to an application using one or more trained model; obtain, based on inputting the first input data to the application, first response data related to the first intent; based on the first response data and the second input data, generate third input data; input the third input data to the application; based on inputting the third input data to the application, obtain second response data related to the second intent; and provide, based on the second response data, a service on the second domain, associated with a service on the first domain.

According to an embodiment, a method performed by an electronic device may include: based on a language-based user input, identifying first input data including first intent related to a first domain, and second input data including second intent related to a second domain; inputting the first input data to an application; obtaining, based on inputting the first input data to the application, first response data related to the first intent; generating, based on the first response data and the second input data, third input data; inputting the third input data to the application; obtaining, based on inputting the third input data to the application, second response data related to the second intent; and providing, based on the second response data, a service on the second domain, associated with a service on the first domain.

According to an embodiment, a non-transitory computer readable storage medium may store one or more programs. The one or more programs may comprise instructions that, when executed by at least one processor of an electronic device, may cause the electronic device to: based on a language-based user input, identify first input data including first intent related to a first domain, and second input data including second intent related to a second domain; input the first input data to an application; obtain, based on inputting the first input data to the application, first response data related to the first intent; generate, based on the first response data and the second input data, third input data; input the third input data to the application; based on inputting the third input data to the application, obtain second response data related to the second intent; and based on the second response data, provide a service on the second domain, associated with a service on the first domain.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment;

FIG. 2A illustrates an example of operation of a conversational application according to an embodiment;

FIG. 2B illustrates an example of a schematic block diagram of an electronic device according to an embodiment;

FIG. 3 illustrates a flowchart of operation of an electronic device according to an embodiment;

FIGS. 4A and 4B illustrate examples of an electronic device and a server for providing a service based on a user input based on multi-turn and/or multi-intent, according to an embodiment;

FIG. 5 illustrates an example of operation of an electronic device for configuring input data of a third artificial intelligence model, according to an embodiment;

FIG. 6 illustrates an example of operation of an electronic device for configuring output data to a user input, according to an embodiment;

FIGS. 7A and 7B illustrate examples of operation of an electronic device according to an embodiment;

FIGS. 8A and 8B illustrate examples of operation of an electronic device according to an embodiment;

FIGS. 9A and 9B illustrate examples of operation of an electronic device according to an embodiment;

FIGS. 10A, 10B, and 10C illustrate examples of operation of an electronic device according to an embodiment;

FIGS. 11A and 11B illustrate examples of operation of an electronic device according to an embodiment;

FIG. 12 illustrates an example of operation of an electronic device according to an embodiment;

FIG. 13 illustrates an example of operation of an electronic device according to an embodiment;

FIG. 14 illustrates an example of operation of an electronic device according to an embodiment;

FIG. 15 illustrates an example of operation of an electronic device according to an embodiment;

FIGS. 16A and 16B illustrate examples of operation of an electronic device according to an embodiment;

FIG. 17 illustrates an example of operation of an electronic device according to an embodiment;

FIG. 18 is a block diagram illustrating an integrated intelligence system according to an embodiment;

FIG. 19 is a diagram illustrating a form of relationship information between concepts and operations stored in a database, according to various embodiments;

FIG. 20 is a diagram illustrating a screen of processing a voice input received through an intelligent app by a user terminal, according to various embodiments; and

FIG. 21 is a schematic diagram of an example of artificial intelligence (AI) system.

The same reference numerals are used to represent the same elements throughout the drawings.

### MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and configurations may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described in the disclosure can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

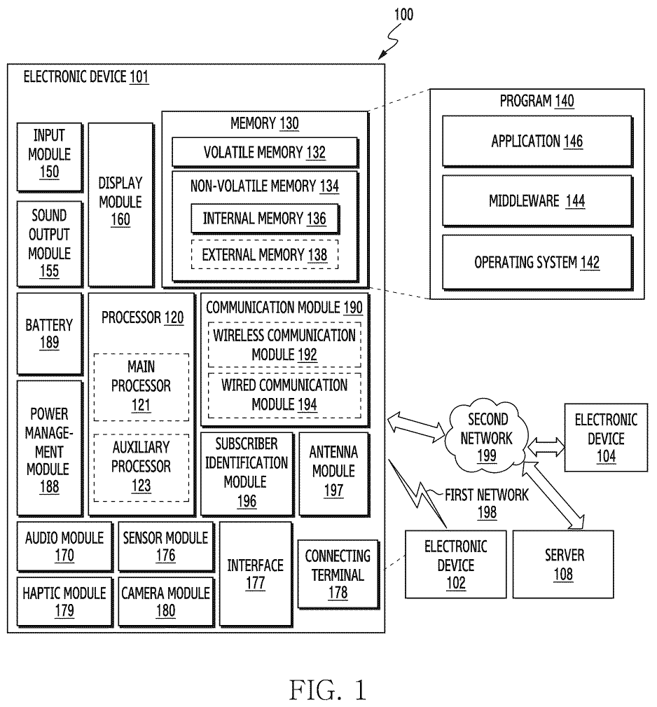

FIG. 1 is a block diagram of an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may change a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may change an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mm Wave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side exterior surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to an embodiment, the electronic device (e.g., the electronic device 101) may provide an interactive artificial intelligence service using a conversational application. The electronic device may receive a language-based user input. For example, the language-based user input may include at least one of a text input and/or a voice input.

The electronic device may input the input data according to a language-based user input to a third artificial intelligence model (e.g., an interactive artificial intelligence model). The electronic device may obtain the output data based on an output of the third artificial intelligence model. The electronic device may display a language-based response message according to the output data through a user interface of a conversational application or may perform a function according to the output data.

According to an embodiment, the language-based user input may be configured in various ways. The language-based user input may be configured based on multi-turn and/or multi-intent. A function for providing a proper response to the language-based user input configured based on the multi-turn and/or multi-intent may be required. In the following description, a specific example of an electronic device (or server) for providing a proper response to the language-based user input configured based on the multi-turn and/or multi-intent will be made. An electronic device (or a user terminal) described below may correspond to the electronic device 101 of FIG. 1.

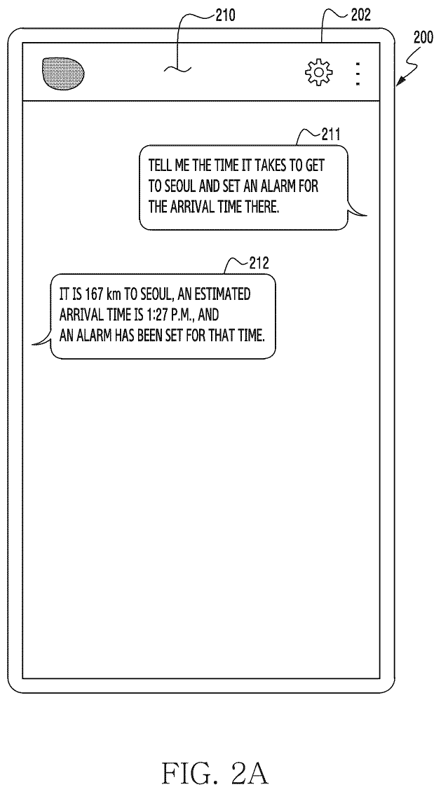

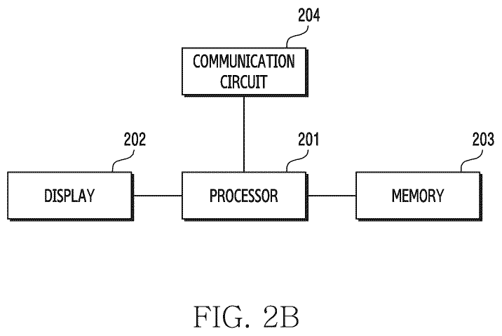

FIG. 2A illustrates an example of an operation of a conversational application according to an embodiment.

Referring to FIG. 2A, an electronic device 200 may include the electronic device 101 of FIG. 1. The electronic device 200 may be a terminal owned by a user. The terminal may include, for example, a personal computer (PC) such as a laptop computer and a desktop computer, a smartphone, a smart pad, a tablet PC or the like. The terminal may include a smart accessory such as a smartwatch and/or a head-mounted device (HMD).

According to an embodiment, the electronic device 200 may execute a conversational application. For example, the electronic device 200 may execute a conversational application based on a pre-defined utterance. The electronic device 200 may identify the utterance based on the user's voice signal. Based on identifying whether the identified utterance corresponds to the pre-defined utterance, the electronic device 200 may execute a conversational application. For example, the conversational application may be referred to as an artificial intelligence assistant application.

According to an embodiment, the conversational application may be used to provide various functions according to a third artificial intelligence model (e.g., the artificial intelligence model). The electronic device 200 may obtain a language-based user input using the conversational application. The electronic device 200 may identify input data including an intent based on the language-based user input. The intent may indicate an operation to be performed by the electronic device 200. When the electronic device 200 receives a language-based user input such as e.g., “Find me a plane ticket to New York”, the electronic device 200 may identify an operation according to “Find me a plane ticket” as an intent, which is an operation to be performed by the electronic device 200. The electronic device 200 may identify “New York” as an entity representing additional information of the intent. For example, the electronic device 200 may obtain input data including an entity (e.g., “New York”) and an intent (e.g., an operation according to “Find me a plane ticket”), based on a language-based user input (e.g., “Find me a plane ticket to New York”). According to an embodiment, an entity may refer to a word or phrase representing a specific object or data. For example, the electronic device 200 may recognize an entity from text through an entity recognition model and extract necessary information. For example, in the case of a language-based input of a user, such as “Find me a plane ticket to New York”, “New York” or “a plane ticket” may be classified as an entity, and “Find me a ticket” may be classified as an intent.

According to an embodiment, an intent may represent a concept used for natural language processing in artificial intelligence in order to grasp an intention or purpose of a user. For example, for the natural language processing used in artificial intelligence, the intention (or intent) of the user may be classified based on a text input through an intent classification model.

For example, the conversational application may have authority to execute other application and perform a function of the other applications. For example, the conversational application may display a user interface of other application within the conversational application, based on executing the other application. The electronic device 200 may provide a function of the other application, using the user interface of the other application displayed in the conversational application.

For example, an intent may be related to a domain. The domain may include an application or a service. The domain may indicate an application or service for performing an operation according to the intent. For example, when the electronic device 200 identifies an operation according to “Find me an airplane ticket” as an intent, the electronic device 200 may identify an airline ticket search application in the domain. As a non-limiting example, the domain may be related to a function regarding at least one of software or hardware. As a non-limiting example, the domain may be related to a unit for performing an operation (or task). As a non-limiting example, the domain may be related to an area of operation performed according to the intent. As a non-limiting example, the domain may be described as a location where processing related to the intent is performed. For example, a first intent may be related to a first domain and a second intent may be related to a second domain. For example, processing of the electronic device 200 with respect to the first intent may be performed on the first domain (e.g., including a hardware component of the electronic device 200 and/or a software component of the electronic device 200), and processing of the electronic device 200 with respect to the second intent may be performed on the second domain (e.g., including a hardware component of the electronic device 200 and/or a software component of the electronic device 200). As a non-limiting example, the second intent may be related to the first intent, and the processing of the second intent may be performed using a result of the processing of the first intent. For example, the second domain may be used for processing of applying the result of the first intent processed on the first domain to the second intent.

According to an embodiment, the electronic device 200 may display the user interface 210 of the conversational application through the display 202. For example, in the electronic device 200, an object 211 representing a language-based user input may be displayed on a first part (e.g., a right side) of the user interface 210. An object 212 representing a language-based response message according to the language-based user input may be displayed on a second part (e.g., a left side) of the user interface 210.

For example, the electronic device 200 may identify input data including an intent based on the language-based user input. The electronic device 200 may input the input data to a third artificial intelligence model. The electronic device 200 may obtain output data using the third artificial intelligence model into which the input data is input. The electronic device 200 may identify the language-based response message based on the output data. The electronic device 200 may display the object 212 representing the language-based response message.

According to an embodiment, the language-based user input may be configured based on multi-turn and/or multi-intent.

For example, the language-based user input configured based on the multi-turn may include consecutive requests for the same and/or similar topic (or conversational content). For example, “How is the weather today” may be received as the user's first input. The electronic device 200 may provide information on today's weather condition based on a location of the electronic device 200, in response to the first input. After the information on the today's weather is provided, “What about tomorrow?” may be received as the user's second input. In response to the second input, the electronic device 200 may provide information on tomorrow's weather based on the location of the electronic device 200. After the information on tomorrow's weather is provided, “Seoul?” may be received as a user's third input. In response to the third input, the electronic device 200 may provide information on tomorrow's weather in Seoul. As described above, for example, the electronic device 200 may change the third input such as “Seoul?” into an input capable of processing (or understanding) in the third artificial intelligence model (e.g., an artificial intelligence model), such as “How is the weather in Seoul tomorrow?”. Thus, without any modification to the third input, a consecutive input for the same and/or similar topic (or conversational content) may be supported. According to an embodiment, such a generative model (or a generative artificial intelligence model) may convert a user input so that the user's intention may be clearly understood. Thus, without the user's additional modification or effort, continuous inputs may be supported while maintaining the context.

For example, the language-based user input configured based on a multi-intent may include a plurality of intents. The electronic device 200 may generate (or identify) first input data including the first intent and second input data including the second intent based on the language-based user input.

For example, as a language-based user input, “Change the dinner schedule to 7 o'clock and pass the schedule to Mike” may be received. The electronic device 200 may generate (or identify) first input data including a first intent such as “Change the dinner schedule to 7 o'clock” and second input data including a second intent such as “Text Mike that the dinner schedule is changed to 7 o'clock.”

For example, like the object 211, “Tell me the time it takes to get to Seoul and set an alarm for the arrival time there” may be received as a language-based user input. The electronic device 200 may generate (or identify) the first input data including the first intent such as “Tell me the time it takes to get to Seoul from the current location” and the second input data including the second intent such as “Set an alarm for the arrival time in Seoul”.

For example, the language-based user input may be configured based on both multi-turn and multi-intent. As an example, “Find a plane ticket to New York in June” may be received as a user's first input. In response to the first input, the electronic device 200 may provide information indicating a plane ticket to New York in June. “July?” may be received as the user's second input. The electronic device 200 may change the second input such as “July?” into an input capable of processing (or understanding) in the third artificial intelligence model (e.g., an artificial intelligence model), such as “Find a plane ticket to New York in July”. For example, “Find for less than $100, and let me know the weather at that time” may be received as a user's third input. Based on the third input, the electronic device 200 may generate (or identify) the first input data including the first intent such as “Find a plane ticket to New York for less than $100 in July” and the second input data including the second intent such as “Let me know the weather in New York in July.”

The components of the electronic device 200 according to the above-described embodiments will be described later with reference to FIG. 2B.

FIG. 2B illustrates an example of a simplified block diagram of an electronic device according to an embodiment.

Referring to FIG. 2B, the electronic device 200 may include at least some or all of the components of the electronic device 101 of FIG. 1. For example, the electronic device 200 may correspond to the electronic device 101 of FIG. 1.

According to an embodiment, the electronic device 200 may include at least one of a processor 201, a display 202, a memory 203, and/or a communication circuit 204. For example, at least some of the processor 201, the display 202, the memory 203, and/or the communication circuit 204 may be omitted according to an embodiment.

According to an embodiment, the processor 201 may include at least a part of the processor 120 of FIG. 1 or may correspond to at least a part of the processor 120. For example, the processor 201 may include one or more processors including an application processor (AP) and/or a communication processor (CP). For example, the processor 201 may be implemented with a single chip such as a system on chip (SoC) or may be implemented with a plurality of chips. For example, the processor 201 may be implemented as a single integrated circuit or may be implemented with a plurality of integrated circuits. For example, the processor 201 may be arranged in the electronic device 200 in a distributed manner.

The processor 201 may be operatively or operably coupled or connected with the display 202, the memory 203, and the communication circuit 204. For example, when the processor 201 is operatively coupled with another component, it may mean that the processor 201 may control other component. The processor 201 may control the display 202, the memory 203, and/or the communication circuit 204.

According to an embodiment, the display 202 of the electronic device 200 may output visualized information (e.g., a screen) to a user. For example, the display 202 may be controlled by a controller such as e.g., a graphic processing unit (GPU), and output visualized information to the user. The display 202 may include a liquid crystal display (LCD), a plasma display panel (PDP), and/or one or more light emitting diodes (LEDs). The LED may include an organic LED (OLED). The display 202 may include a flat panel display (FPD) and/or electronic paper. Embodiments are not limited thereto, and the display 202 may have an at least partially curved form or a deformable form. The display 202 having a deformable form may be referred to as a flexible display.

According to an embodiment, the memory 203 of the electronic device 200 may include a circuit and/or a storage medium for storing data and/or instructions input and/or output to and from the processor 201. The memory 203 may include, for example, a volatile memory such as a random-access memory (RAM) and/or a non-volatile memory such as a read-only memory (ROM). The non-volatile memory may be referred to as storage. The volatile memory may include, for example, at least one of dynamic RAM (DRAM), static RAM (SRAM), cache RAM, or pseudo SRAM (PSRAM). The non-volatile memory may include, for example, at least one of programmable ROM (PROM), erasable PROM (EPROM), electrically erasable PROM (EEPROM), flash memory, hard disk, compact disk, solid state drive (SSD), or embedded multi-media card (eMMC).

According to an embodiment, the memory 203 may include at least a part of the memory 130 of FIG. 1 or may correspond to at least a part of the memory 130 of FIG. 1. For example, the memory 203 may be implemented as a single chip or may be implemented as a plurality of chips. For example, the memory 203 may be implemented as a single integrated circuit or may be implemented as a plurality of integrated circuits. For example, the memory 203 may be arranged within the electronic device 200 in a distributed manner.

According to an embodiment, the processor 201 of the electronic device 200 may execute instructions of the memory 203 in the electronic device 200 to perform functions and/or operations indicated by the instructions. For example, when the electronic device 200 includes at least one processor, the at least one processor may be configured to execute the instructions collectively or individually.

For example, the memory 203 may include at least one model (or at least one artificial intelligence model). The memory 203 may store instructions regarding at least one model. The memory 203 may include (or store) at least one of a first artificial intelligence model, a second artificial intelligence model, and/or a third artificial intelligence model to be described below. According to an embodiment, at least one of the first artificial intelligence model and/or the second artificial intelligence model may be a language-based artificial intelligence model. According to an embodiment, at least one of the first artificial intelligence model, the second artificial intelligence model, and/or the third artificial intelligence model may be included in a chip (e.g., NPU) that is distinguished from the memory 203. For example, at least one of the first artificial intelligence model, the second artificial intelligence model, and/or the third artificial intelligence model may be implemented as an artificial intelligence model included in hardware (e.g., an artificial intelligence chip) included in a separate device (on device artificial intelligence) or an external server.

For example, the first artificial intelligence model, the second artificial intelligence model, and/or the third artificial intelligence model may be configured based on at least one artificial intelligence model. According to an embodiment, the third artificial intelligence model may be configured based on at least one of a rule model and/or a deep model. The first artificial intelligence model and the second artificial intelligence model may be configured based on a generative model (or a generative artificial intelligence model). However, the disclosure is not limited thereto.

In an embodiment, the generative model may include a generative model including a plurality of parameters related to a neural network having a structure based on an encoder and a decoder, such as a transformer. In an embodiment, the generative model may include a bi-directional model (e.g., bidirectional encoder representations from transformers, BERT) based on learning about an encoder, or an auto-encoding model (e.g., a diffusion model). In an embodiment, the generative model may include an auto-regressor model (e.g., a generative pre-trained transformer, GPT) based on learning about a decoder. In an embodiment, the generative model may include a sequence-to-sequence model (e.g., stable diffusion, DALL-E 2) based on learning about the encoder and decoder. In an embodiment, the generative model may include a large language model (LLM) for processing natural language based on massive parameters. However, the disclosure is not limited thereto. The generative models may include parameters for driving neural networks such as CNN (convolutional natural network), RNN (recurrent natural network), feedforward natural network (FNN), and/or long short-term memory (LSTM).

According to an embodiment, the communication circuit 204 may be used for various radio access technologies (RATs). For example, the communication circuit 204 may be used to perform Bluetooth communication, wireless local area network (WLAN) communication, or ultra-wideband (UWB) communication. For example, the communication circuit 204 may be used to perform cellular communication. For example, the processor 201 may establish a connection with an external electronic device (e.g., a server) through the communication circuit 204.

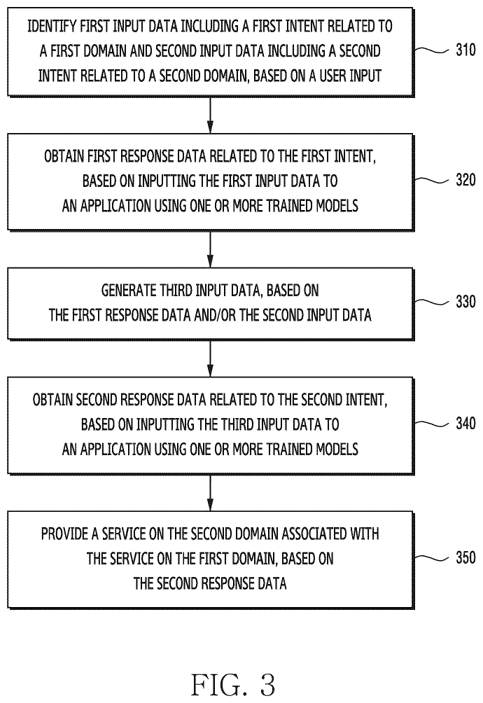

FIG. 3 is a flowchart illustrating an operation of an electronic device, according to an embodiment. In the following embodiment, respective operations may be performed sequentially, but may not be necessarily performed sequentially. For example, the order of respective operations may be changed, and at least two operations may be performed in parallel.

Referring to FIG. 3, in operation 310, the electronic device 200 (or the processor 201 of electronic device 200) may generate (or identify) first input data including a first intent related to a first domain and second input data including a second intent related to a second domain, based on a user input.

According to an embodiment, the electronic device 200 may display a user interface of a conversational application on the display 202 based on execution of the conversational application. The electronic device 200 may obtain a user input while the user interface of the conversational application is displayed. For example, the user input may include at least one of text input and/or voice input. According to an embodiment, the user input may be configured based on language-based text, language-based voice, image, emoticon, number, and/or gesture.

According to an embodiment, the electronic device 200 may input a user input to a first artificial intelligence model. The electronic device 200 may generate (or identify or obtain) first input data including the first intent and/or second input data including the second intent, based on inputting the user input to the first artificial intelligence model. The first artificial intelligence model may be used to identify (or distinguish) the intent from the user input. For example, the first artificial intelligence model may be configured to regenerate a natural sentence that an artificial intelligence model (e.g., a third artificial intelligence model) can process. For example, the electronic device 200 may identify (or generate) a prompt using the user input and/or history information (e.g., information about previous user inputs). The electronic device 200 may generate the first input data and/or the second input data through the first artificial intelligence model based on the identified prompt.

In operation 320, the electronic device 200 may input the first input data to an application using one or more trained models. The electronic device 200 may obtain first response data related to the first intent, based on inputting the first input data to an application using the one or more trained models. For example, the application using one or more trained models may be referred to as at least one of an assistant application (or voice assistant application), an assistant function (or voice assistant function), an assistant program (or voice assistant program), or an auxiliary operation (or voice assistant operation).

For example, the application may include one or more trained models. The application may be configured to obtain response data according to input data. The application may be configured to obtain the response data using at least one of one or more models to be trained according to the intent of the input data. Each of the one or more trained models may be related to the intent. For example, a first model of the one or more trained models may be related to the first intent. A second model of the one or more trained models may be related to the second intent.

For example, the application using one or more trained models may operate in association with a conversational application. For example, the application using one or more trained models may be configured to obtain response data to the input data obtained through the conversational application. For example, the application using one or more trained models may be configured to perform an auxiliary function for a user's voice input. For example, the application using one or more trained models may be configured to obtain output data based on voice data obtained through the conversational application.

According to an embodiment, the electronic device 200 may obtain first response data related to the first intent, based on inputting the first input data to a trained model (e.g., a third artificial intelligence model, a generative artificial intelligence model). For example, the electronic device 200 may input the first input data to the trained model. For example, the trained model may correspond to the first model related to the first intent.

The electronic device 200 may input the first input data to the trained model to obtain the first response data to the first input data including the first intent. The electronic device 200 may identify the first domain related to the first intent. The electronic device 200 may identify the first domain (e.g., application or service) for performing the first intent. The electronic device 200 may obtain the first response data as an output value of the third artificial intelligence model, using the first input data as an input value of the third artificial intelligence model. For example, the first response data may be used to provide a service on the first domain. The electronic device 200 may provide a service on the first domain, based on the first response data. According to an embodiment, the electronic device 200 may display the language-based response message according to the first response data in the user interface of the conversational application.

For example, the trained model may be used to perform a function related to a conversational application. The trained model may be used to generate (or obtain) output data according to input data. For example, the trained model may be configured based on a rule model and/or a deep model. However, the disclosure is not limited thereto. The trained model may be configured based on a generative model.

According to an embodiment, the first response data according to the first input data may be obtained through a third-party application or a chat AI (e.g., Gemini or chat-GPT (generative pre-trained transformer)) using LLM.

In operation 330, the electronic device 200 may generate third input data based on the first response data and/or the second input data. For example, the electronic device 200 may generate the third input data based on inputting at least one of the first response data or the second input data to the first artificial intelligence model. According to an embodiment, the electronic device 200 may generate the third input data, based on inputting history information (e.g., information on a previous user input) as well as the first response data and/or the second response data, to the first artificial intelligence model. For example, the electronic device 200 may identify (or generate) a prompt, using the first response data, the second input data and/or the history information (e.g., information on a previous user input). The electronic device 200 may generate the third input data through the first artificial intelligence model, based on the identified prompt.

For example, the electronic device 200 may input the first response data, which is a result of the first input data, and the second input data, to the first artificial intelligence model. The electronic device 200 may generate the third input data based on an output of the first artificial intelligence model. For example, the electronic device 200 may change the second input data into the third input data by reflecting the first response data to the second input data. The electronic device 200 may change the second input data into the third input data that may be processed (or understood) in the trained model. For example, the third input data may include a second intent included in the second input data. When the second input data is changed to a third intent, the second intent of the second input data may be maintained, and a parameter of the second input data may be changed.

According to an embodiment, the third input data generated according to operation 330 may include the third intent. Even in the case that the second input data includes the second intent, the third intent distinguished from the second input data may be included in the third input data, according to the output of the first artificial intelligence model.

In operation 340, the electronic device 200 may input the third input data to an application using one or more trained models. The electronic device 200 may obtain the second response data related to the second intent, based on inputting the third input data to the application using one or more trained models.

According to an embodiment, the electronic device 200 may obtain the second response data related to the second intent, based on inputting the third input data to the trained model. For example, the electronic device 200 may input the third input data to the trained model. The electronic device 200 may obtain the second response data related to the second intent, based on the output of the trained model. For example, the trained model may correspond to the second model related to the second intent.

According to an embodiment, the second response data according to the third input data may be obtained through a third-party application or a chat AI (e.g., Gemini or chat-GPT (generative pre-trained transformer)) using LLM.

In operation 350, the electronic device 200 may provide a service on the second domain associated with the service on the first domain, based on the second response data. For example, the service on the second domain may be performed based on the service on the first domain. To obtain the second response data, the third input data obtained based on the first response data may be used. Accordingly, the service on the second domain may be connected to the service on the first domain.

In the above-described embodiments, an example for obtaining the second response data has been described, but the disclosure is not limited thereto. For example, N input data including the fourth input data or the fifth input data and N response data may be obtained. According to an embodiment, N-th input data may be obtained based on the response data according to the first input data to the response data according to (N−1)-th input data.

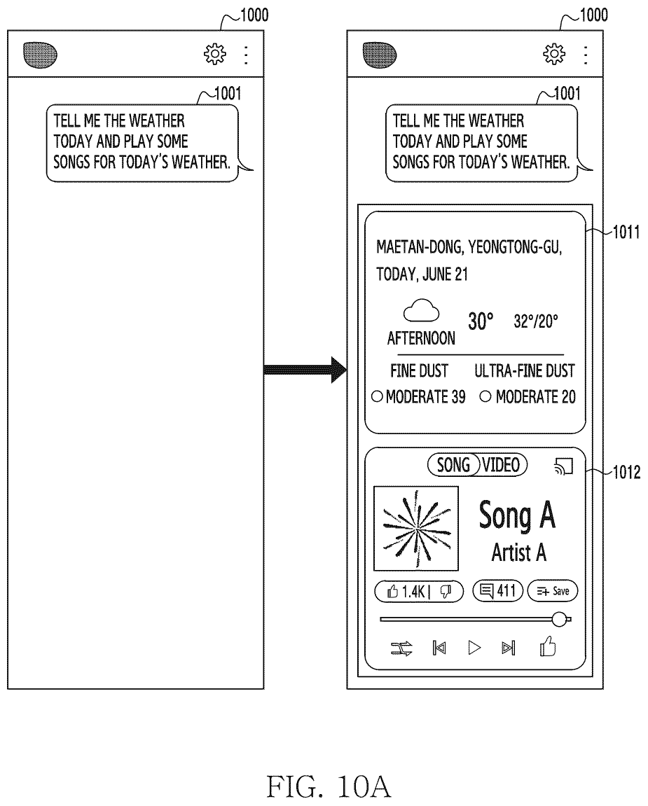

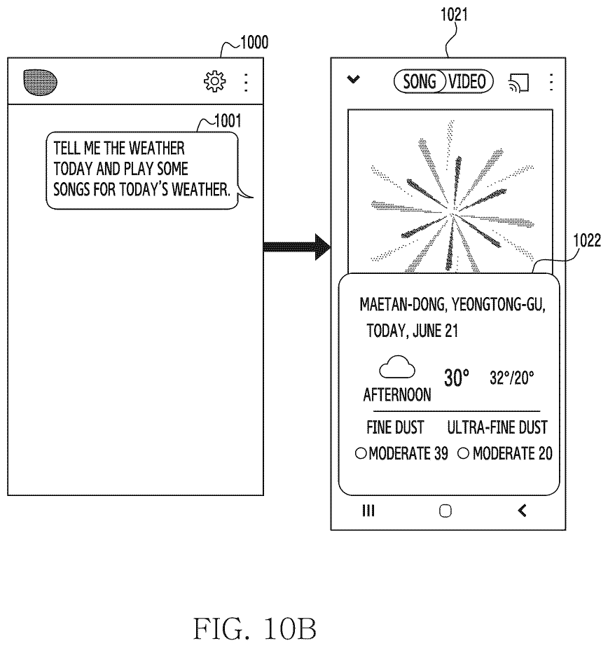

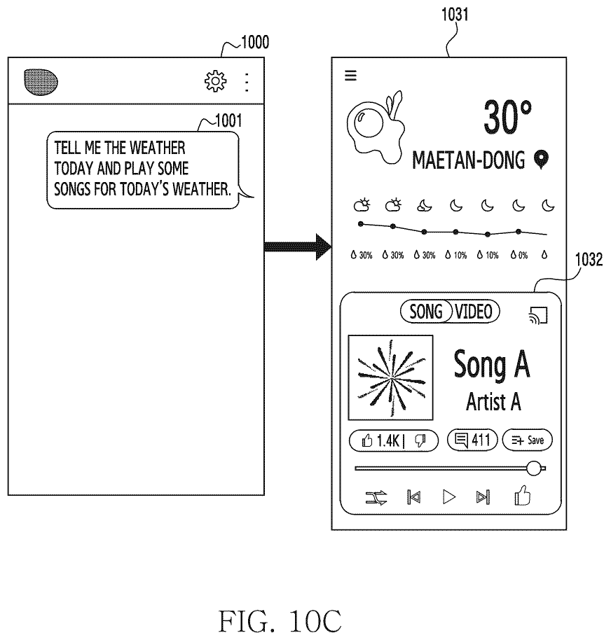

According to an embodiment, the electronic device 200 may provide a service on the first domain, based on the first response data. For example, in order to provide a service on the first domain based on the first response data in the user interface of the conversational application, the electronic device 200 may display a first user interface of a first application related to the first domain. In order to provide a service on the second domain based on the second response data within the user interface of the conversational application, the electronic device 200 may display a second user interface of a second application related to the first domain. An example in which the first user interface of the first application and the second user interface of the second application are displayed in the user interface of the conversational application will be described later with reference to FIG. 10A.

For example, the first response data may be used to cause execution of the first application and execution of a function related to the first application. The electronic device 200 may, based on the first response data, execute the first application, and perform the function related to the first application. For example, the second response data may be used to cause execution of the second application and execution of a function related to the second application. The electronic device 200 may, based on the second response data, execute the second application and perform the function related to the second application.

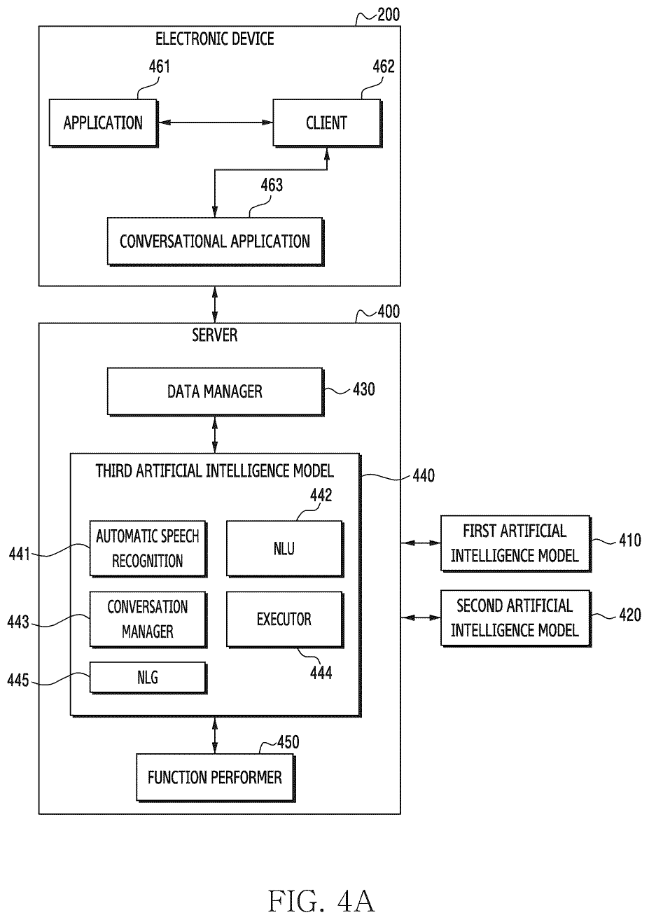

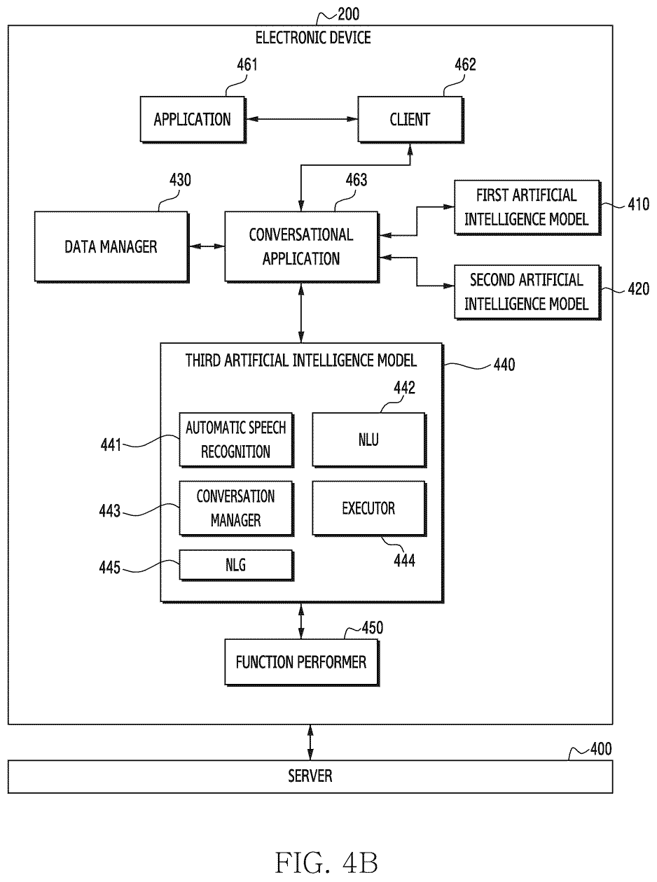

According to an embodiment, the electronic device 200 may cease displaying the user interface of the conversational application, based on the first response data and the second response data. The electronic device 200 may display the first user interface of the first application related to the first domain on the display 202. After displaying the first user interface, the electronic device 200 may display the second user interface of the second application related to the second domain, overlapping the first user interface, through the display 202. An example in which the second user interface is displayed overlapping the first user interface will be described later with reference to FIG. 10B. According to an embodiment, the first user interface and the second user interface may not be displayed overlappingly. According to an embodiment, the first user interface and the second user interface may not be displayed, and objects according to the first response data and the second response data may be displayed within the conversational application. For example, the electronic device 200 may generate (or obtain) the output data, based on inputting the first response data and the second response data to a second artificial intelligence model 420 (e.g., the second artificial intelligence model 420 of FIG. 4A or 4B). The electronic device 200 may display an object according to the output data in the conversational application.

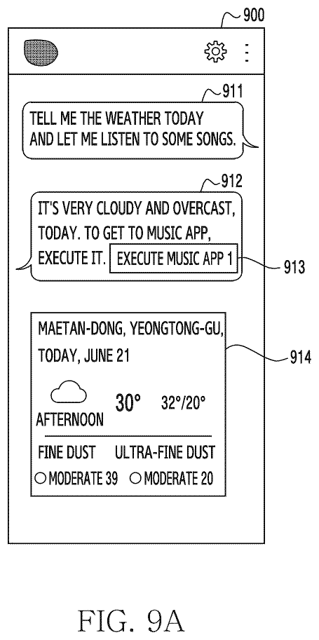

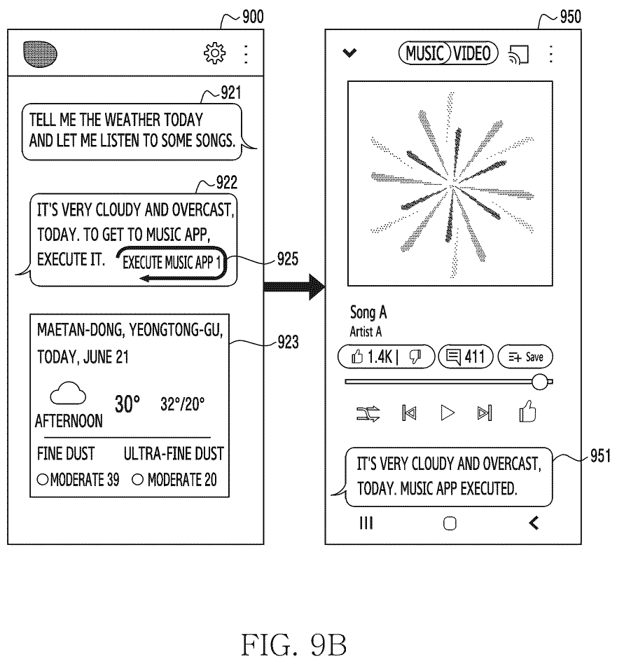

According to an embodiment, the processor 201 may display at least one of a first object for executing the first application related to the first domain or a second object for executing the second application related to the second domain in the user interface of the conversational application. For example, the electronic device 200 may, based on an input to the first object, execute the first application and display the first user interface of the first application on the display 202. For example, the electronic device 200 may, based on an input to the second object, execute the second application and display the second user interface of the second application on the display 202. An example of displaying the first object and/or the second object will be described later with reference to FIGS. 9A and 9B.

According to an embodiment, the electronic device 200 may generate output data for a user input based on the first response data and the second response data. For example, the electronic device 200 may generate the output data for the user input, based on the first response data and the second response data, to display a response message to the user input. The electronic device 200 may display a language-based response message according to the output data within the user interface of the conversational application. The language-based response message may be displayed as a reply message to the user input.

For example, the electronic device 200 may input the first response data and the second response data to the second artificial intelligence model. The electronic device 200 may generate the output data for the user input, based on inputting the first response data and the second response data to the second artificial intelligence model.

For example, the second artificial intelligence model may be used to generate a natural response, based on the first response data and the second response data. For example, the second artificial intelligence model may be referred to as a rewriting natural language generator (NLG).

For example, the first artificial intelligence model may be used for processing input data. The second artificial intelligence model may be used for processing output data. For example, the first artificial intelligence model and/or the second artificial intelligence model may be configured based on a generative model (e.g., a large language model (LLM)). According to an embodiment, at least one of the first artificial intelligence model and the second artificial intelligence model may be a language-based model (or a language-based artificial intelligence model). According to an embodiment, the first artificial intelligence model and the second artificial intelligence model may be one artificial intelligence model (or a language-based model). For example, the second artificial intelligence model may correspond to the first artificial intelligence model.

For example, the first artificial intelligence model may be used to identify inputs according to multi-turn and/or multi-intent, based on a user input. The first artificial intelligence model may provide a function of dividing off the user input into inputs that can be processed (or understood) in a trained model (e.g., a third artificial intelligence model). The first artificial intelligence model may be used to change second input data into third input data to which the first response data is reflected. For example, the first artificial intelligence model may change the user input into a natural language format supported by a trained model (e.g., the third artificial intelligence model).

As an example, the second artificial intelligence model may be used to combine the first response data and the second response data. The second artificial intelligence model may be used to generate a natural language based on a database according to the domain of the performed function. The second artificial intelligence model may generate language-based (or natural language-based) output data in response to the user input, based on a history of previously performed functions (or tasks) of the user input, surrounding environmental information, user input, and/or response data (e.g., first response data and second response data).

According to an embodiment, the electronic device 200 may identify that a time duration for obtaining the second response data exceeds a threshold time. The electronic device 200 may generate first output data according to the first response data and first provide the first output data. After the first output data is provided, the electronic device 200 may, based on obtaining the second response data, generate output data according to the second response data and provide the second output data.

According to an embodiment, the trained model may be configured based on at least one of a rule model and/or a deep model. The trained model may not process user input including intents for various domains. For example, the first artificial intelligence model and the second artificial intelligence model may be configured based on the generated model. Accordingly, the electronic device 200 may divide off the user input into first input data and second input data using the first artificial intelligence model. The first input data and the second input data may be processed by the trained model.

The electronic device 200 may obtain the third input data based on the first response data and the second input data, using the first artificial intelligence model. The electronic device 200 may obtain third input data based on the first response data and the second response data, thereby obtaining the third input data from a user input configured based on multi-turn and/or multi-intent. The electronic device 200 may obtain the second response data by inputting the third input data to the trained model.

The electronic device 200 may obtain output data by inputting the first response data and the second response data to the second artificial intelligence model. The electronic device 200 may provide the user with a response message according to a user input configured based on the multi-turn and/or the multi-intent, by obtaining output data.

While in FIG. 3 the first artificial intelligence model, the second artificial intelligence model, and/or the trained model (or the third artificial intelligence model) have been described as independent, the disclosure is not limited thereto. In the disclosure, the first artificial intelligence model, the second artificial intelligence model, and/or the trained model (or the third artificial intelligence model) may be configured as one model.

According to an embodiment, the output data according to the first response data and the second response data may be obtained through a third-party application or a chat AI (e.g., Gemini or chat-generative pre-trained transformer (GPT)) using LLM.

FIGS. 4A and 4B illustrate an example of an electronic device and a server for providing a service according to a user input based on multi-turn and/or multi-intent according to an embodiment.

Referring to FIGS. 4A and 4B, the electronic device 200 may use a server 400 to provide a service according to a user input based on multi-turn and/or multi-intent. In FIG. 4A, an example of a third artificial intelligence model 440, one example of the trained model described above, included in the server 400 will be described. In FIG. 4B, an example will be described in which the third artificial intelligence model 440, one example of the trained model described above, is included in the electronic device 200.

Referring to FIG. 4A, the electronic device 200 may include an application 461, a client 462, and a conversational application 463. The application 461, the client 462, and the conversational application 463 may be included (or stored) in the memory 203 of the electronic device 200.

For example, the application 461 may be an application for providing a service according to a user input. The application 461 may be related to an intent included in the user input. The application 461 may be related to a domain according to the intent. The application 461 may be related to the domain related to the intent. For example, the client 462 may be used for communication with the server 400. The client 462 may be used for access to the server 400. For example, the conversational application 463 may be used to receive a user input and provide output data according to the user input. For example, the conversational application 463 may be set to have authority to execute the application 461. The conversational application 463 may be set to have authority to execute functions in the application 461.

According to an embodiment, the server 400 may include a data manager 430, a third artificial intelligence model 440, and a function performer 450. For example, the data manager 430 may be used to manage input data and/or output data of the third artificial intelligence model 440. For example, when the number of intents is n, the data manager 430 may serve to store and manage a history in order to sequentially process each of the intents. For example, the data manager 430 may manage a plurality of (e.g., n) histories of results of the preceding processing. According to an embodiment, when a generated artificial intelligence model is used, the data manager 430 may perform a function to modify or write at least one prompt for the generated artificial intelligence model. For example, the third artificial intelligence model 440 may be used to obtain output data based on input data. The function performer 450 may be used to perform a function according to the output data. The function performer 450 may be used to perform a function according to a domain (or capsule) of the output data. The function performer 450 may perform a service provided from an external device that is distinguished from the electronic device 200 or the server 400. According to an embodiment, the third artificial intelligence model may be an example of an application. The application may be configured to use one or more trained models. For example, the application may be referred to as at least one of assistant application (or voice assistance application), assistant function (or voice assistant function), assistant program (or voice assistance program), or assistant operation (application) (or voice assistant operation). For example, the application may include one or more trained models. The application may be configured to obtain response data according to input data. The application may be configured to obtain response data, using at least one of one or more models to be trained according to the intent of the input data. For example, each of the one or more trained models may be related to the intent. For example, a first model among one or more trained models may be related to a first intent. Among the one or more trained models, a second model may be related to a second intent.

For example, an application using one or more trained models may operate in association with a conversational application. For example, the application using one or more trained models may be configured to obtain response data to input data obtained through the conversational application.

For example, a first artificial intelligence model 410 may be used to identify inputs according to multi-turn and/or multi-intent, based on a user input. The first artificial intelligence model 410 may be used to change second input data into third input data in which the first response data is reflected. For example, a second artificial intelligence model 420 may be used to combine the first response data and the second response data. For example, the second artificial intelligence model 420 may be used to generate third input data, based on history information (e.g., conversation history information) as well as the first response data and/or the second response data. According to an embodiment, the first artificial intelligence model 410 and the second artificial intelligence model 420 may be configured as one model (e.g., a language-based model). For example, the second artificial intelligence model 420 may correspond to the first artificial intelligence model 410.

According to an embodiment, the first artificial intelligence model 410 and/or the second artificial intelligence model 420 may be included in another server distinguished from the server 400. According to an embodiment, the first artificial intelligence model 410 and/or the second artificial intelligence model 420 may be included in the server 400.

For example, the third artificial intelligence model 440 may include an automatic speech recognition (ASR) 441, a natural language understanding (NLU) 442, a conversation manager 443, an executor 444, and a natural language generation (NLG) 445.

For example, the third artificial intelligence model 440 may be configured to obtain response data to a language-based user input. The third artificial intelligence model 440 may be used to identify a function performed according to a language-based user input. For example, the first artificial intelligence model 410 and the second artificial intelligence model 420 may be used for reconfiguration of the language-based user input. For example, the first artificial intelligence model 410 may be configured to divide off the language-based user input having two intents into first input data regarding the first intent and second input data regarding the second intent. For example, the first artificial intelligence model 410 may be set to generate third input data based on the first response data and the second response data. For example, the second artificial intelligence model 420 may be set to generate a response message to be provided to the user, based on the first response data and the second response data.

The automatic speech recognition 441 may be used to convert voice data into text in units of sentences. The NLU 442 may be used to infer (or understand) a user's intention from input data. The NLU 442 may be used to understand and interpret the meaning of the text. The conversation manager 443 may be used to manage flow and/or context of the conversation. The executor 444 may be used to perform functions according to response data (or output data).

Referring to FIG. 4B, the electronic device 200 may include at least some or all of the functional blocks included in the server 400 of FIG. 4A. The server 400 of FIG. 4B may correspond to the server 400 of FIG. 4A.

For example, the electronic device 200 may include at least one of a data manager 430, a third artificial intelligence model 440, a function performer 450, a first artificial intelligence model 410, and/or a second artificial intelligence model 420. When the electronic device 200 includes at least one of the data manager 430, a third artificial intelligence model 440, the function performer 450, the first artificial intelligence model 410, and/or the second artificial intelligence model 420, at least one of the data manager 430, the third artificial intelligence model 440, the function performer 450, the first artificial intelligence model 410, and/or the second artificial intelligence model 420, included in the electronic device 200, may not be included in the server 400.

According to an embodiment, the electronic device 200 may include the data manager 430, the third artificial intelligence model 440, the first artificial intelligence model 410, and the second artificial intelligence model 420. For example, the data manager 430, the third artificial intelligence model 440, the first artificial intelligence model 410, and the second artificial intelligence model 420 may be embedded in the electronic device 200. Even when the electronic device 200 includes the data manager 430, the third artificial intelligence model 440, the first artificial intelligence model 410, and the second artificial intelligence model 420, the server 400 may include the data manager 430, the third artificial intelligence model 440, the first artificial intelligence model 410, and the second artificial intelligence model 420. When receiving a user input, the electronic device 200 may determine a device for processing the user input.

For example, when the device for processing the user input is determined as the electronic device 200, the electronic device 200 may obtain response data (or output data) to the user input and provide the response data (or output data), using the data manager 430, the third artificial intelligence model 440, the first artificial intelligence model 410, and the second artificial intelligence model 420, included in the electronic device 200.

For example, when the device for processing the user input is determined to be the server 400, the electronic device 200 may transmit the user input to the server 400. The server 400 may obtain response data (or output data) to the user input, and provide the response data (or output data) to the electronic device 200.

According to an embodiment, the electronic device 200 may perform at least some of the functions according to FIG. 3. The server 400 may perform the remainder of the functions according to FIG. 3.

Hereinafter, in the following description, operations of the electronic device 200 including the data manager 430, the third artificial intelligence model 440, the first artificial intelligence model 410, and the second artificial intelligence model 420, as shown in FIG. 4B, will be described. However, the description is only for convenience of explanation. According to an embodiment, at least some of the operations of the electronic device 200 may be performed in the server 400. For example, when an operation related to the third artificial intelligence model 440 is performed in the server 400, the electronic device 200 may obtain first input data and second input data based on a user input, and transmit the first input data and the second input data to the server 400. The server 400 may transmit first response data with respect to the first input data to the electronic device 200. The electronic device 200 may obtain third input data based on the first response data and the second input data. The electronic device 200 may transmit the third input data to the server 400. The server 400 may obtain second response data with respect to the third input data, and transmit the first response data to the electronic device 200. In the above-described example, an example in which the operation related to the third artificial intelligence model 440 is performed in the server 400 has been described, but the disclosure is not limited thereto, and similar to the above-described example, at least some of the operations of the electronic device 200 described below may be performed in the server 400.

According to an embodiment, the electronic device 200 may determine a device for processing an input intent or an entity as at least one of the server 400 or the electronic device 200, based on the input intent or the entity. For example, the electronic device 200 may include at least one of the first artificial intelligence model and the second artificial intelligence model. The electronic device 200 may obtain response data for the input intent or entity, using at least one of the first artificial intelligence model and the second artificial intelligence model. The obtained response data may be processed to be merged in the electronic device 200 or the server 400.

Referring to FIGS. 4A and 4B, the first artificial intelligence model 410 and the second artificial intelligence model 420 have been described as independent, but the disclosure is not limited thereto. In the disclosure, the first artificial intelligence model 410 and the second artificial intelligence model 420 may be configured as a single model (e.g., a language-based model).

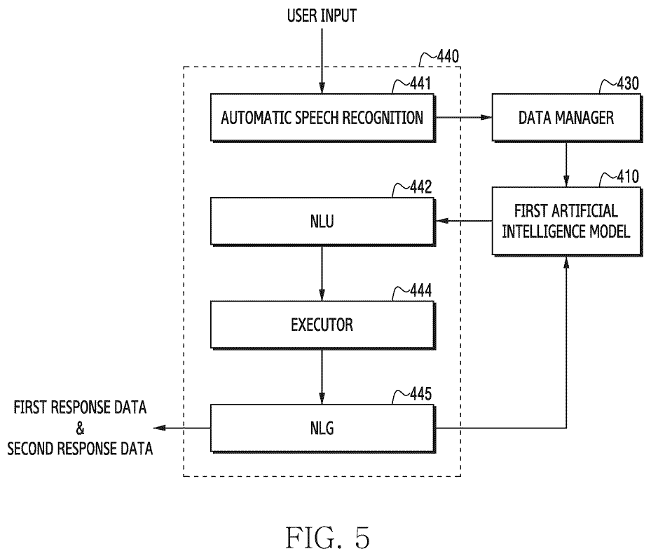

Specific operations of the third artificial intelligence model 440, the first artificial intelligence model 410, and the second artificial intelligence model 420 described above will be described later in FIGS. 5, 6, 7A, and 7B.

FIG. 5 illustrates an example operation of an electronic device for configuring input data of a third artificial intelligence model, according to an embodiment.

Referring to FIG. 5, the electronic device 200 may obtain a user input. Using the automatic speech recognition 441, the electronic device 200 may change a voice based user input into a text based user input. According to an embodiment, when the text based user input is received, the automatic speech recognition 441 may not be used.

The electronic device 200 may add a text-based user input to a prompt defined for the first artificial intelligence model 410, using the data manager 430. For example, in the electronic device 200, a prompt shown in the following table may be defined.

TABLE 1
If the content in [FullInfoText] is composed of multiple intents,
using only the content in [FullInfoText], write separately each intent
in the form of [Intent1] [Intent2], etc. without any additional
information, and write separately each intent with all the
information.
Here's an example of the above.
[History]
“User: Schedule a playdate with Jimin.”
“B: When do you want to save the schedule?”
“User: Tomorrow at 2 pm.”
“B: Should I save the playdate schedule with Jimin for tomorrow at
2pm?”
[Current]
“User: Um, make it 3 o'clock, not 2 o'clock.”
[FullInfoText]
“Cancel saving the playdate schedule with Jimin at 2 pm tomorrow
and schedule the playdate schedule with Jimin at 3 pm tomorrow.”
[Intent1]
“Cancel saving the playdate schedule with Jimin at 2 pm tomorrow.”
[Intent2]
“Schedule a playdate with Jimin at 3 pm tomorrow.”

Referring to the Table 1, the electronic device 200 may define a prompt configured as shown in the Table 1 for the first artificial intelligence model 410. The electronic device 200 may add a user input to the prompt defined for the first artificial intelligence model 410 to configure input data of the first artificial intelligence model 410. For example, the prompt may include history information. For example, a conversation history prior to the user input may be configured as history information. The electronic device 200 may configure the conversation history (or another user input) prior to the user input as history information.

For example, the electronic device 200 may use the data manager 430 to configure input data of the first artificial intelligence model based on the user input. The electronic device 200 may use the data manager 430 to configure data in the form capable of processing in the first artificial intelligence model.

As described above, based on the prompt and/or few-shot (or one-shot), the first artificial intelligence model 410 may identify one or more intents using the history information and the user input. The electronic device 200 may identify input data for each of the one or more intents. For example, based on the user input, the electronic device 200 may identify the first intent and the second intent, using the first artificial intelligence model 410. The electronic device 200 may identify first input data including the first intent and second input data including the second intent, using the first artificial intelligence model 410.

For example, when the first input data including the first intent and the second input data including the second intent are identified using the first artificial intelligence model 410, the electronic device 200 may perform a natural language interpretation operation on the first input data using the NLU 442. The electronic device 200 may perform an execution associated with an application or a service, using the executor 444, based on the natural language interpretation on the first input data, and may obtain first natural language generator (NLG) information regarding a result of the execution, using the NLG 445. For example, the electronic device 200 may identify the first NLG information and first result information of the execution associated with the application or service, as first response data.

According to an embodiment, the electronic device 200 may input the first response data and the second input data to the first artificial intelligence model 410. The electronic device 200 may obtain third input data using the first artificial intelligence model 410. The electronic device 200 may obtain second response data based on the third input data, using the NLU 442, the executor 444, and the NLG 445. For example, the electronic device 200 may identify the second NLG information and second result information of the execution associated with the application or service, as the second response data.

As described above, the electronic device 200 may process the user input including a plurality of intents for a plurality of domains to obtain response data for various types of user inputs (e.g., multi-turn or multi-intent). The electronic device 200 may provide a conversation function having continuity according to various types of user inputs.

For example, the electronic device 200 may identify n intents using the first artificial intelligence model 410. The electronic device 200 may rewrite a sentence to be composed of input data, using response data of the third artificial intelligence model 440 for each intent. The electronic device 200 may rewrite a sentence to be composed of input data, by accumulating response data for the n intents. For example, the electronic device 200 may rewrite a sentence to be composed of input data, by repeatedly performing the operations regarding the first artificial intelligence model 410, the NLU 442, the executor 444, and/or the NLG 445.

For example, the electronic device 200 may identify a user input such as “Turn on Bluetooth and play a song”. The electronic device 200 may identify first input data including a first intent such as “Turn on Bluetooth” and second input data including a second intent such as “Play a song”. The electronic device 200 may obtain first response data for the first input data, using the third artificial intelligence model 440. The electronic device 200 may identify that the function can be performed without changing the second input data according to the first response data. The electronic device 200 may obtain second response data for the second input data, using the third artificial intelligence model 440. The electronic device 200 may perform an operation of turning on Bluetooth and an operation of playing a song, based on obtaining the first response data and the second response data. According to an embodiment, the third artificial intelligence model 440 may be an example of an application using one or more trained models. The application may be configured to use one or more trained models. For example, the application may include one or more trained models. The application may be configured to obtain response data according to input data. The application may be configured to obtain the response data, using at least one of one or more models to be trained according to an intent of the input data. For example, each of the one or more trained models may be related to the intent. For example, a first model among the one or more trained models may be related to a first intent. A second model among the one or more trained models may be related to a second intent. For example, the electronic device 200 may use the first model among the one or more trained models included in the application in order to obtain the first response data for the first input data. For example, the electronic device 200 may use the second model among the one or more trained models included in the application in order to obtain the second response data to the third input data.

For example, the electronic device 200 may identify a user input such as “Register tomorrow's Seoul schedule and let me know the weather then.” The electronic device 200 may identify first input data including a first intent such as “Register tomorrow's Seoul schedule” and second input data including a second intent such as “Let me know the weather then.” The electronic device 200 may obtain first response data for the first input data, using the third artificial intelligence model 440. The electronic device 200 may change the second input data into third input data according to the first response data. The electronic device 200 may obtain third input data such as “Let me know tomorrow's Seoul weather.” For example, the third input data may include a second intent for a weather request. However, the disclosure is not limited thereto, and the intent included in the third input data may be different from the intent included in the second input data. The electronic device 200 may obtain second response data for the third input data, using the third artificial intelligence model 440. Based on obtaining the first response data and the second response data, the electronic device 200 may perform an operation of registering tomorrow's Seoul schedule and an operation of providing tomorrow's Seoul weather.

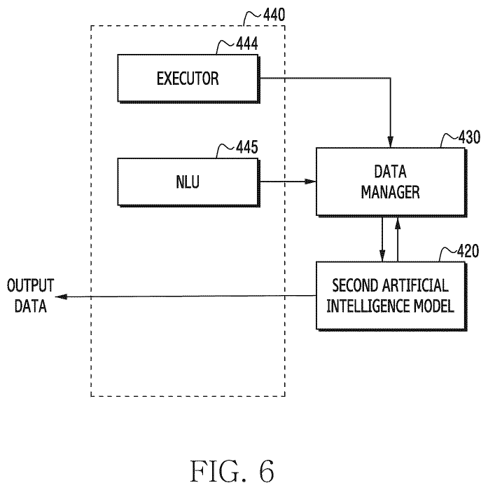

FIG. 6 illustrates an example of an operation of an electronic device for configuring output data for a user input, according to an embodiment.

Referring to FIG. 6, as shown in FIG. 5, the electronic device 200 may provide the data manager 430 with first NLG information obtained using the executor 444 and the NLG 445, and first response data including first result information of an execution associated with an application or service. The electronic device 200 may provide the data manager 430 with second response data including second NLG information obtained using the executor 444 and the NLG 445 and second result information of an execution associated with an application or service.

The electronic device 200 may add the first response data (e.g., first NLG information) and the second response data (e.g., second NLG information) to a prompt defined for the second artificial intelligence model 420, using the data manager 430. For example, in the electronic device 200, a prompt shown in the following table may be defined.

TABLE 2
[Intent] represents an intent of a user included in [FullInfoText], and
[Result] represents a result performed and processed by B through each
[Intent].
[Response] should be based on the information present in
[FullInfoText] or [Result].
Please write [Response] suitable for [Language].
Here's an example.
[Language] Korean
[FullInfoText] Set an alarm at 7 o'clock and send a message to Min-
sung Kim
[Intent1] Set an alarm at 7 o'clock
[Result1] The alarm has been set.
[Intent2] Send a message to Min-sung Kim
[Result2] What should I send to Min-sung Kim?
[Response: Simple] The alarm has been set, and what should I send to
Min-sung Kim?
[Response: Detail] The alarm has been set, and what should I send to
Min-sung Kim?

Referring to the Table 2 above, the electronic device 200 may define a prompt configured as shown in the Table 2 for the second artificial intelligence model 420. The electronic device 200 may configure input data of the second artificial intelligence model 420 by adding first response data (e.g., first NLG information) and/or second response data (e.g., second NLG information) to the prompt defined for the second artificial intelligence model 420. For example, the prompt may include history information. For example, a conversation history prior to the user input may be configured as history information.

As described above, based on the prompt and/or few-shot (or one-shot), the second artificial intelligence model 420 may generate third NLG information. The electronic device 200 may configure the third NLG information using the first response data and the second response data. The electronic device 200 may provide a user with a natural sentence for various types of utterances, based on the third NLG information. For example, the third NLG information may be referred to as output data for a user input.

According to an embodiment, the electronic device 200 may store the NLG information (e.g., first NLG information, second NLG information, and third NLG information), using the data manager 430. The NLG information may be managed as history information. The electronic device 200 may provide the output data for the user input, using the history information, while a session for the current conversation is maintained.

According to an embodiment, the electronic device 200 may identify another language-based user input that is not related to the history information. For example, the electronic device 200 may identify that another language-based user input is not related to a pre-received language-based user input. The electronic device 200 may terminate the session for the pre-received language-based user input, and establish a new session for the another language-based user input. For example, the other language-based user input may include a third intent. The electronic device 200 may configure a fourth intent to establish a new session. The electronic device 200 may terminate the existing session by performing an operation according to the fourth intent for establishing a new session. Thereafter, the electronic device 200 may perform an operation according to the third intent. For example, the third intent may include an intent for terminating a session, such as “No”. According to the above-described example, even when receiving a language-based user input having one intent, the electronic device 200 may identify a plurality of intent.

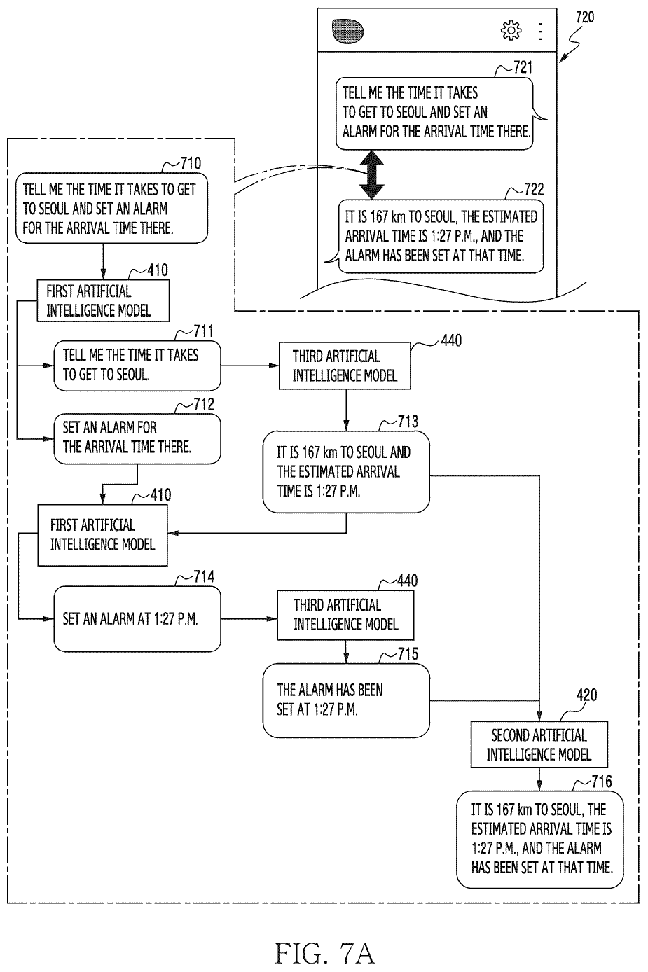

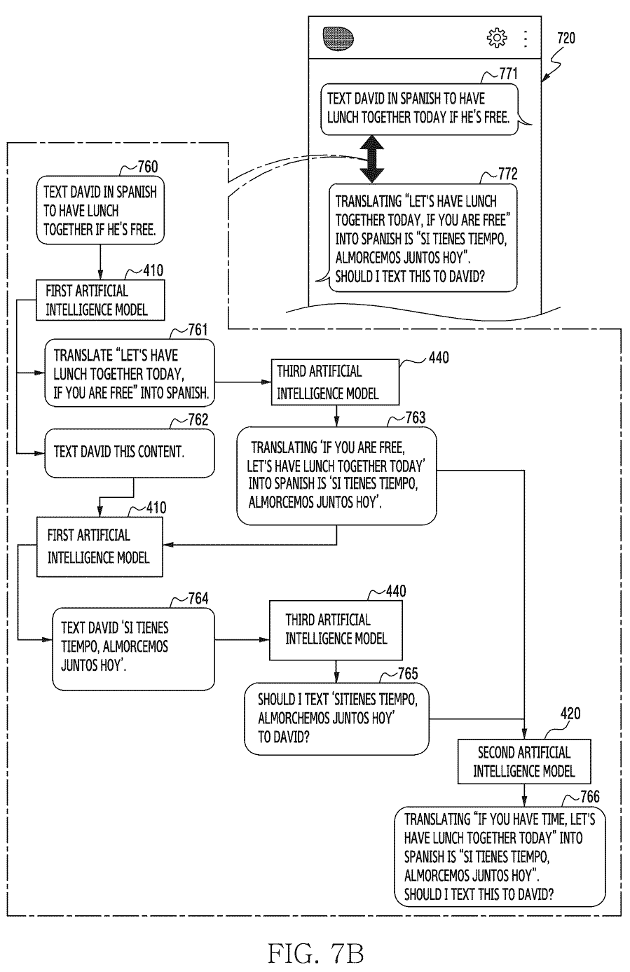

FIGS. 7A and 7B illustrate an example of an operation of an electronic device according to an embodiment.

Referring to FIG. 7A, the electronic device 200 may obtain (or identify) a language-based user input 710. Based on inputting the language-based user input 710 to the first artificial intelligence model 410, the electronic device 200 may identify first input data 711 including a first intent and second input data 712 including a second intent.

For example, the electronic device 200 may obtain (or identify) a language-based user input 710, such as “Tell me the time it takes to get to Seoul and set an alarm for the arrival time there.” The electronic device 200 may identify first input data 711 including a first intent (e.g., Tell me the time), such as “Tell me the time it takes to get to Seoul”, based on the language-based user input 710. The electronic device 200 may identify second input data 712 including a second intent (e.g., set an alarm), such as “Set an alarm for the arrival time there”, based on the language-based user input 710.

According to an embodiment, the electronic device 200 may obtain first response data 713, based on inputting the first input data 711 to the third artificial intelligence model 440. For example, the electronic device 200 may obtain first response data 713, such as “It is 167 km to Seoul, and the estimated arrival time is 1:27 pm.” According to an embodiment, the third artificial intelligence model 440 may be an example of an application using one or more trained models. The application may be configured to use the one or more trained models. For example, the application may include the one or more trained models. Each of the one or more trained models may be associated with an intent. For example, a first model among the one or more trained models may be associated with a first intent. A second model among the one or more trained models may be associated with a second intent. For example, the electronic device 200 may use the first model among the one or more trained models included in the application to obtain first response data 713 for the first input data 711.

According to an embodiment, the electronic device 200 may obtain third input data 714 based on inputting the second input data 712 and the first response data 713 to the first artificial intelligence model 410. For example, the electronic device 200 may obtain the third input data 714, such as “Set an alarm at 1:27 p.m. today.”

The electronic device 200 may obtain second response data 715 based on inputting the third input data 714 to the third artificial intelligence model 440. For example, the electronic device 200 may use the second model among the one or more trained models included in the application to obtain second response data 715 for the third input data 714. For example, the electronic device 200 may obtain the second response data 715, such as “The alarm has been set at 1:27 p.m. today.”

The electronic device 200 may obtain output data 716 based on inputting the first response data 713 and the second response data 715 to the second artificial intelligence model 420. For example, the electronic device 200 may obtain the output data 716 based on history information (e.g., conversation history information) as well as the first response data 713 and the second response data 715. For example, the electronic device 200 may obtain the output data 716, such as “It is 167 km to Seoul, the estimated arrival time is 1:27 p.m., and the alarm has been set at that time.”

According to an embodiment, the electronic device 200 may display an object 721 indicating a user input 710 within a user interface 720 of a conversational application 463. The electronic device 200 may display an object 722 indicating output data 716. The object 722 may represent a response to the object 721.

Referring to FIG. 7B, the electronic device 200 may obtain (or identify) a language-based user input 760. The electronic device 200 may identify first input data 761 including a first intent and second input data 762 including a second intent, based on inputting the language-based user input 760 to the first artificial intelligence model 410.

For example, the electronic device 200 may obtain (or identify) a language-based user input 760, such as “Text David in Spanish to have lunch together if he's free.” Based on the language-based user input 760, the electronic device 200 may identify the first input data 761 including the first intent (e.g., translate it), such as “Text David in Spanish to have lunch together if you are free.” Based on the language-based user input 760, the electronic device 200 may identify second input data 762 including a second intent (e.g., text it), such as “Text David this content.”

The electronic device 200 may obtain first response data 763 based on inputting the first input data 761 to the third artificial intelligence model 440. For example, the electronic device 200 may obtain the first response data 763, such as, e.g., “translating “If you are free, let's have lunch together today” into Spanish is “Si tienes tiempo, almorcemos juntos hoy”.

The electronic device 200 may obtain third input data 764 based on inputting the second input data 762 and the first response data 763 to the first artificial intelligence model 410. For example, the electronic device 200 may obtain the third input data 764 such as “Text David ‘Si tienes tiempo, almorcemos juntos hoy’”.

The electronic device 200 may obtain second response data 765 based on inputting the third input data 764 to the third artificial intelligence model 440. For example, the electronic device 200 may obtain the second response data 765 such as “Should I text ‘Sitienes tiempo, almorchemos juntos hoy’ to David?”

The electronic device 200 may obtain output data 766 based on inputting the first response data 763 and the second response data 765 into the second artificial intelligence model 420. For example, the electronic device 200 may obtain the output data 766, such as “Translating ‘If you are free, let's have lunch together today’ into Spanish is Si tienes tiempo, almorcemos juntos hoy. Should I text this to David?”

According to an embodiment, the electronic device 200 may display an object 771 indicating a user input 760 within a user interface 720 of the conversational application 463. The electronic device 200 may display an object 772 indicating the output data 766. The object 722 may represent a response to the object 771.

Although the first artificial intelligence model 410 and the second artificial intelligence model 420 are respectively illustrated in FIGS. 7A and 7B, the first artificial intelligence model 410 and the second artificial intelligence model 420 may be configured as a single artificial intelligence model. According to embodiments, the first artificial intelligence model 410, the second artificial intelligence model 420, and the third artificial intelligence model 440 may be configured as a single artificial intelligence model.

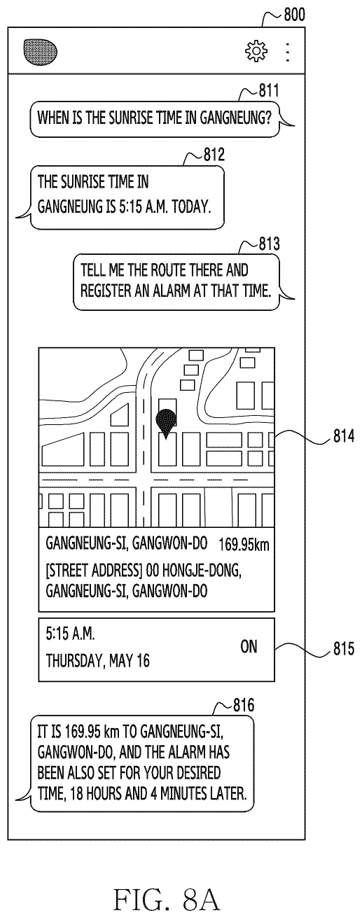

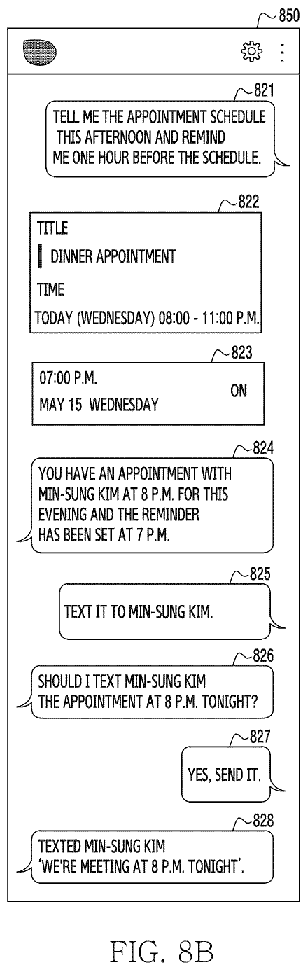

FIGS. 8A and 8B illustrate an example of an operation of an electronic device according to an embodiment.

Referring to FIG. 8A, FIG. 8A illustrates an example of a result screen (or user interface) according to results of processing for a plurality of intents. The result screen according to the results of processing for the plurality of intents may be changed according to an embodiment. The electronic device 200 may display output data according to a conversation context.

Referring to FIG. 8A, the electronic device 200 may display a user interface 800 of a conversational application 463. The electronic device 200 may display an object 811 representing a first user input on the user interface 800. The electronic device 200 may obtain output data in response to the first user input. The electronic device 200 may display an object 812 indicating the output data.

The electronic device 200 may display an object 813 indicating a second user input on the user interface 800. The electronic device 200 may identify the first input data and the second input data based on the second user input. The electronic device 200 may identify the first input data, such as “Tell me the route there”. The electronic device 200 may identify the second input data, such as “Set an alarm at that time”.

The electronic device 200 may display a first user interface 814 of a first application (e.g., a map application) in the user interface 800 to provide a service on a first domain (e.g., a map service), based on the first response data according to the first input data. According to an embodiment, the first user interface 814 may include at least one of an image, a video, and/or an executable object.

The electronic device 200 may display a second user interface 815 of a second application (e.g., a watch application) in the user interface 800 to provide a service on a second domain (e.g., a time service), based on the first response data and the second input data. According to an embodiment, the second user interface 815 may include at least one of an image, a video, and/or an executable object.

The electronic device 200 may obtain output data for a user input, based on the first response data and the second response data. The electronic device 200 may display an object 816 indicating the output data for the user input in the user interface 800.

Referring to FIG. 8B, FIG. 8B illustrates an example of a result screen (or user interface) according to a processing result for multi-intent and multi-turn. The electronic device 200 may display a user interface 850 of the conversational application 463. The electronic device 200 may display an object 821 indicating a first user input on the user interface 850.

The electronic device 200 may identify the first input data and the second input data based on a first user input. The electronic device 200 may identify the first input data, such as “Tell me the dinner appointment schedule this afternoon.” The electronic device 200 may identify the second input data, such as “Remind me one hour before the schedule.”

The electronic device 200 may display, in the user interface 850, a user interface 822 of a first application (e.g., a calendar application) for providing a service on a first domain (e.g., a schedule service), based on the first response data according to the first input data. According to an embodiment, the first user interface 822 may include at least one of an image, an image, and/or an executable object.

The electronic device 200 may display a second user interface 823 of a second application (e.g., a notification application) in the user interface 850 to provide a service on a second domain (e.g., a notification service), based on the first response data and the second input data. According to an embodiment, the second user interface 823 may include at least one of an image, a video, and/or an executable object.

The electronic device 200 may display an object 824 representing output data for the first user input in the user interface 850.

The electronic device 200 may display an object 825 indicating a second user input on the user interface 850. The electronic device 200 may obtain response data for the second user input, based on history information and the second user input. For example, the history information may include output data according to the first user input or information on an execution result of the first application or the second application.

The electronic device 200 may display, in the user interface 850, an object 826 for inquiring whether to perform an operation according to response data to the second user input. The electronic device 200 may display in the user interface 850 an object 827 according to an input indicating acceptance for performing an operation according to response data to the second user input.

The electronic device 200 may perform an operation according to response data to the second user input through a third application (e.g., a text application) for providing a service on a third domain (e.g., a text service), based on response data to the second user input. The electronic device 200 may display an object 828 in the user interface 850, indicating that the operation according to the response data to the second user input has been performed.

As described above, the electronic device 200 may provide responses according to user inputs configured based on multi-intent and multi-turn.

FIGS. 9A and 9B illustrate an example of an operation of an electronic device according to an embodiment.

Referring to FIGS. 9A and 9B, the electronic device 200 may display a user interface 900 of the conversational application 463 through the display 202.

Referring to FIG. 9A, the electronic device 200 may identify a language-based user input including a plurality of intents. The electronic device 200 may display an object 911 representing the language-based user input on the user interface 900.

The electronic device 200 may obtain first input data including a first intent (e.g., tell me the weather) related to a first domain (e.g., a weather service) and second input data including a second intent (e.g., play a song) related to a second domain (e.g., a music service), based on a language-based user input. The electronic device 200 may obtain first response data based on inputting the first input data to the third artificial intelligence model 440. The electronic device 200 may obtain second response data based on inputting the second input data to the third artificial intelligence model 440.

The electronic device 200 may obtain the output data based on the first response data and the second response data. The electronic device 200 may display an object 912 based on the output data. For example, the object 912 may include an object 913 for executing an application (e.g., a music application) related to a second domain. The electronic device 200 may execute the application related to the second domain, based on an input to the object 913.

The electronic device 200 may display a user interface 914 of the first application (e.g., a weather application) related to the first domain to provide a service on the first domain, based on the first response data.

Referring to FIG. 9B, the electronic device 200 may identify a language-based user input including a plurality of intents. The electronic device 200 may display an object 921 representing a language-based user input on the user interface 900.

The electronic device 200 may obtain first input data including a first intent (e.g., tell me the weather) related to a first domain (e.g., a weather service) and second input data including a second intent (e.g., play a song) related to a second domain (e.g., a music service), based on the language-based user input. The electronic device 200 may obtain first response data based on inputting the first input data to the third artificial intelligence model 440. The electronic device 200 may obtain second response data based on inputting the second input data to the third artificial intelligence model 440.

The electronic device 200 may obtain output data, based on the first response data and the second response data. The electronic device 200 may display an object 922 based on the output data. The electronic device 200 may display a user interface 923 of the first application (e.g., a weather application) related to the first domain to provide a service on the first domain, based on the first response data.

For example, the object 922 may include an object 925 for executing an application (e.g., a music application) related to a second domain. The object 925 may include an element (e.g., an arrow) indicating time. The object 925 may indicate that the application related to the second domain will be executed after a predetermined time has elapsed. Although not shown herein, the object 925 may indicate the elapsed time.

For example, the electronic device 200 may execute an application related to the second domain, based that a predetermined time has elapsed or identifying a user input for the object 925. Based on execution of the application related to the second domain, the electronic device 200 may suspend displaying the user interface 900 of the conversational application 463 and display the user interface 950 of the application related to the second domain. The electronic device 200 may display a user interface 951 of the conversational application 463 in overlapping with the user interface 950. The user interface 951 of the conversational application 463 may indicate a response according to a language-based user input.

FIGS. 10A, 10B, and 10C illustrate an example of an operation of an electronic device according to an embodiment.

Referring to FIGS. 10A, 10B, and 10C, the electronic device 200 may display a user interface 1000 based on execution of the conversational application 463. The electronic device 200 may identify a language-based user input including a plurality of intents. The electronic device 200 may display an object 1001 representing a language-based user input on the user interface 1000.

The electronic device 200 may obtain first input data including a first intent (e.g., Tell me the weather) related to a first domain (e.g., a weather service) and second input data including a second intent (e.g., Play a song) related to a second domain (e.g., a music service), based on a language-based user input. The electronic device 200 may obtain first response data based on inputting the first input data to the third artificial intelligence model 440. The electronic device 200 may obtain third input data based on the first response data and the second input data. The electronic device 200 may obtain second response data based on inputting the third input data to the third artificial intelligence model 440.

Referring to FIG. 10A, the electronic device 200 may display a user interface 1011 of the first application regarding the first domain in order to provide a service on the first domain, based on the first response data, within the user interface 1000 of the conversational application 463. For example, the first response data may cause the electronic device 200 to display information related to today's weather through the weather application. The first response data may include data causing the electronic device 200 to provide today's weather through the weather application. For example, when it is determined that the first intent includes a command to inform the weather, the electronic device 200 may determine the weather application related to the weather as the first application, and may provide the user with an interface 1011 for displaying information related to today's weather output from the first application, using some information (e.g., today's weather) of the user input.

The electronic device 200 may display a user interface 1012 of the second application regarding the second domain to provide a service on the second domain, based on the second response data. For example, the user interface 1011 of the first application and the user interface 1012 of the second application may be displayed within the user interface 1000 of the conversational application 463. According to an embodiment, the user interface 1011 of the first application and the user interface 1012 of the second application may be displayed as one user interface. The electronic device 200 may generate a new user interface, using the user interface 1011 including at least one of the functions of the first application and the user interface 1012 including at least one of the functions of the second application. The electronic device 200 may display the new user interface in the user interface 1000 of the conversational application 463. For example, the second response data may cause the electronic device 200 to play music related to today's weather. The first response data may include data causing the electronic device 200 to play (or provide) the music related to today's weather. For example, when it is determined that the second intent includes a command related to a playback of music, the electronic device 200 may determine a music playback application related to the music playback as the second application and provide a user interface 1022 for playing music related to today's weather to the user.

Referring to FIG. 10B, the electronic device 200 may suspend displaying the user interface 1000 of the conversational application 463. The electronic device 200 may display the user interface 1021 of the first application related to the first domain on the display 202. The electronic device 200 may display the user interface 1022 of the second application related to the second domain, as at least partial overlay of the user interface 1021 of the first application.

Referring to FIG. 10C, the electronic device 200 may suspend displaying the user interface 1000 of the conversational application 463. The electronic device 200 may display a user interface 1031 of the second application regarding the second domain on the display 202. The electronic device 200 may display a user interface 1032 of the first application regarding the first domain, at least partially overlapping the user interface 1031 of the second application.

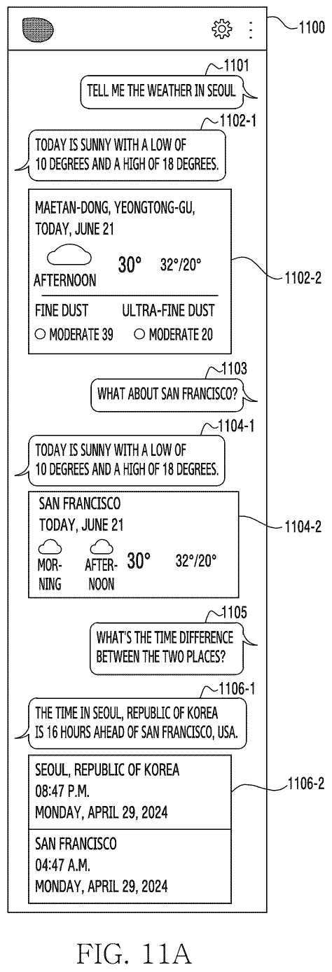

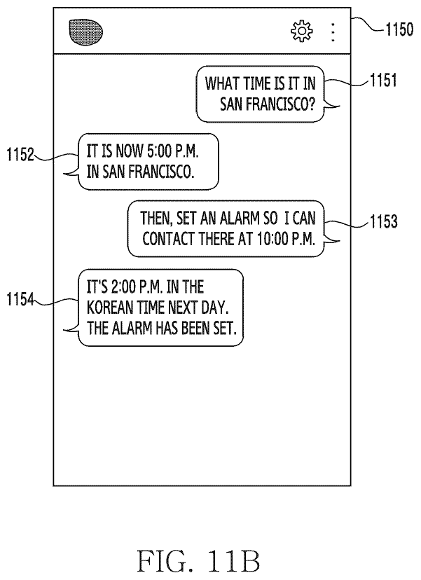

FIGS. 11A and 11B illustrate an example of an operation of an electronic device according to an embodiment.

Referring to FIGS. 11A and 11B, the electronic device 200 may provide a response according to each of the user inputs, based on the user inputs based on multi-turn.

Referring to FIG. 11A, the electronic device 200 may identify a first user input, a second user input, and a third user input. For example, the first user input may be “Tell me the weather in Seoul”. The second user input may be “How about San Francisco?” The third user input may be “What is the time difference between the two places?”

For example, the electronic device 200 may display an object 1101 representing the first user input in a user interface 1100 of the conversational application 463 (e.g., the conversational application 463 of FIG. 4). The electronic device 200 may display an object 1102-1 and a user interface 1102-2 on the user interface 1100, based on response data to the first user input. The electronic device 200 may input the input data according to the first user input to the third artificial intelligence model. The electronic device 200 may obtain response data to the first user input, based on inputting the input data according to the first user input to the third artificial intelligence model. The response data to the first user input may include text representing information on the weather in Seoul, and data for executing (or displaying) a weather application representing the weather in Seoul.

According to an embodiment, the electronic device 200 may display an object 1103 representing the second user input in the user interface 1100 of the conversational application 463. The electronic device 200 may obtain response data to the second user input, based on the history information and the second user input. For example, the history information may include response data to the first user input. For example, the history information may be maintained while the session is maintained.

For example, the electronic device 200 may input the input data according to the second user input and the history information (e.g., response data to the first user input) to the first artificial intelligence model. The electronic device 200 may generate (or obtain) other input data (e.g., weather information in San Francisco), based on inputting the input data according to the user input and the history information to the first artificial intelligence model. The electronic device 200 may obtain response data to the second user input, based on inputting the other input data to the third artificial intelligence model. According to an embodiment, the other input data may include a prompt. The response data to the second user input may include text indicating information about the weather in San Francisco, and data for executing (or displaying) a weather application indicating the weather in San Francisco.

According to an embodiment, the electronic device 200 may display an object 1104-1 and a user interface 1104-2 on the user interface 1100, based on the response data to the second user input. The electronic device 200 may add the response data to the second user input to the history information.

According to an embodiment, the electronic device 200 may display an object 1105 representing the third user input in the user interface 1100 of the conversational application 463. The electronic device 200 may obtain response data to the third user input, based on the history information and the third user input. For example, the history information may include the response data to the first user input and the response data to the second user input.

For example, the electronic device 200 may input the input data according to the third user input and the history information (e.g., the response data to the first user input and the response data to the second user input) to the first artificial intelligence model. The electronic device 200 may generate (or obtain) other input data (e.g., Tell me the time difference between Seoul and San Francisco), based on inputting the input data according to the third user input and the history information to the first artificial intelligence model. The electronic device 200 may obtain response data to the third user input, based on inputting the other input data to the third artificial intelligence model. According to an embodiment, the other input data may include a prompt. The response data to the third user input may include text indicating the time difference between Seoul and San Francisco, and data for executing (or displaying) a clock application indicating the time of each of Seoul and San Francisco.

The electronic device 200 may display an object 1106-1 and a user interface 1106-2 on the user interface 1100, based on the response data to the second user input. The electronic device 200 may add the response data to the third user input to the history information.

According to an embodiment, the electronic device 200 may identify the end of the session. For example, the electronic device 200 may identify the end of the session, based on identifying that the topic of conversation has changed. For example, the electronic device 200 may identify the end of the session, based on identifying that no user input is received for a time duration exceeding a threshold time. The electronic device 200 may delete (or discard) the history information based on the end of the session.

Referring to FIG. 11B, the electronic device 200 may identify a first user input. The electronic device 200 may display an object 1151 representing the first user input within a user interface 1150 of the conversational application 463. The electronic device 200 may display an object 1152 based on response data to the first user input.

The electronic device 200 may identify a second user input after displaying the object 1152 in response to the first user input. The electronic device 200 may display an object 1153 indicating the second user input in the user interface 1100 of the conversational application 463. The electronic device 200 may obtain response data to the second user input, based on the history information and the second user input. For example, the history information may include the response data to the first user input. For example, the history information may be maintained while the session is maintained. For example, the data manager 430 of the electronic device 200 may manage the history information while the session is maintained. For example, the data manager 430 may accumulate and store the response data to the user input (e.g., the first user input and the second user input) while the session is maintained.

The electronic device 200 may display an object 1154 on the user interface 1150, based on the response data to the second user input. The electronic device 200 may add the response data to the second user input to the history information. The electronic device 200 may identify the end of the session. For example, the electronic device 200 may identify the end of the session, based on identifying that the conversation topic is changed. For example, the electronic device 200 may identify the end of the session, based on identifying that no user input is received for a time duration exceeding a threshold time. The electronic device 200 may delete (or discard) the history information, based on the end of the session.

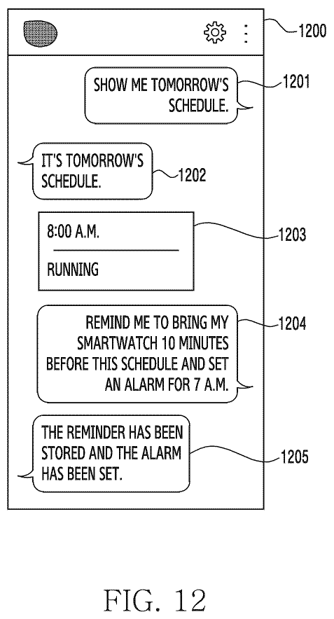

FIG. 12 illustrates an example of an operation of an electronic device according to an embodiment.

Referring to FIG. 12, the electronic device 200 may provide a response according to each of user inputs, based on the user inputs based on multi-intent.

According to an embodiment, the electronic device 200 may display an object 1201 representing a first user input in a user interface 1200 of the conversational application 463. The electronic device 200 may display an object 1202 and a user interface 1203 on the user interface 1200 based on response data to the first user input. For example, the first user input may be “Show me tomorrow's schedule.” Based on the first user input, the electronic device 200 may identify an intent, such as “Show me a schedule”. Based on inputting the first user input to the third artificial intelligence model 440 (e.g., the third artificial intelligence model 440 of FIGS. 4A and 4B), the electronic device 200 may obtain text guiding the schedule tomorrow, and data causing the electronic device 200 to execute a schedule application for displaying the schedule tomorrow.

The electronic device 200 may display an object 1204 representing a second user input in the user interface 1200 of the conversational application 463. Based on the second user input, the electronic device 200 may identify the first input data (e.g., “Remind me to bring my smartwatch 10 minutes before this schedule”) including the first intent and the second input data (e.g., “Set an alarm for 7:00 in the morning”). Based on the history information including the response data to the first user input and the first input data, the electronic device 200 may obtain third input data (e.g., “Remind me to bring my smartwatch 10 minutes before the running schedule at 8 a.m. and set an alarm for 7 a.m.), using the first artificial intelligence model 410 (e.g., the first artificial intelligence model 410 of FIG. 4A or 4B). The electronic device 200 may obtain the first response data based on the third input data. The electronic device 200 may obtain the second response data based on the second input data.

The electronic device 200 may obtain the output data using the second artificial intelligence model 420 (e.g., the second artificial intelligence model 420 of FIG. 4A or 4B), based on the first response data and the second response data. The electronic device 200 may display, in the user interface 1200, an object 1205 representing a language-based response message according to the output data.

According to the above-described embodiment, the electronic device 200 may identify “Remind me to bring my smartwatch 10 minutes before this schedule” as the first input data. The electronic device 200 may obtain the third input data based on the history information (e.g., information on the 8 a.m. learning schedule) and the first input data. The electronic device 200 may obtain the third input data, such as “Remind me to bring my smart watch 10 minutes before the learning schedule at 8 a.m. and set an alarm for 7 a.m.”, using the first artificial intelligence model 410. The electronic device 200 may perform a response to each of the user inputs based on the multi-intent by obtaining the third input data, based on the history information about the conversation history.

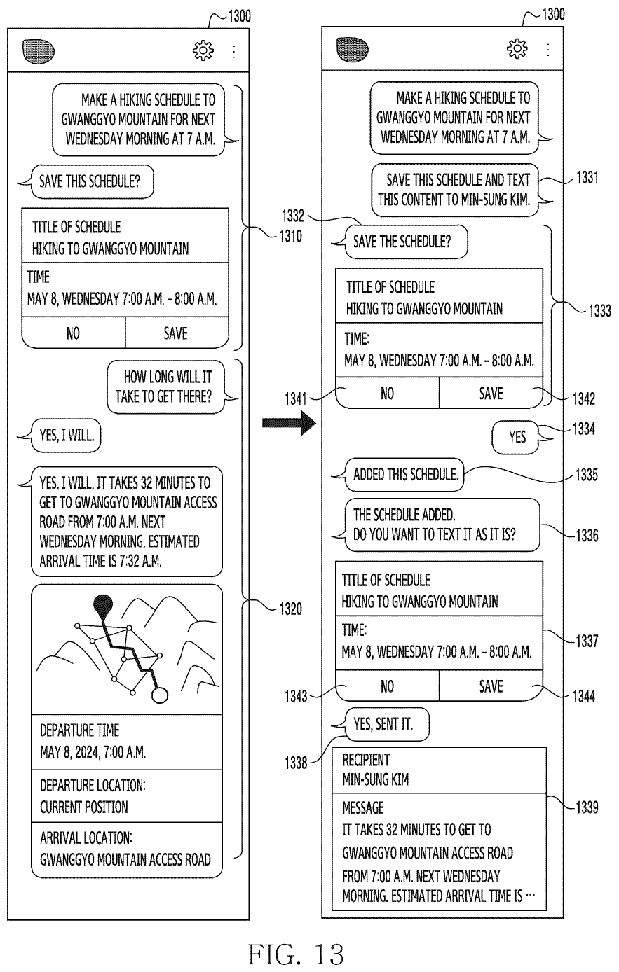

FIG. 13 illustrates an example of an operation of an electronic device according to an embodiment.

Referring to FIG. 13, the electronic device 200 may provide a response to user inputs based on multi-intent, based on the history information.

According to an embodiment, the electronic device 200 may display a first user input and objects 1310 representing a response to the first user input, in a user interface 1300 of the conversational application 463 (for example, the conversational application 463 of FIG. 4A or 4B). The electronic device 200 may display objects 1320 representing a second user input and a response to the second user input, in the user interface 1300. The electronic device 200 may store information on the conversation history as history information.

According to an embodiment, the electronic device 200 may identify a third user input based on the multi-intent. The electronic device 200 may display an object 1331 representing the third user input in the user interface 1300. The electronic device 200 may identify the first input data and the second input data based on the third user input. For example, the third user input may be configured based on a multi-intent including a plurality of intents.

According to an embodiment, the electronic device 200 may identify a third user input, such as “Save the schedule and send the content to Min-sung Kim as well.” The electronic device 200 may identify the first input data, such as “Save the schedule.” The electronic device 200 may identify the second input data, such as “Send the content to Min-sung Kim as well.” For example, the electronic device 200 may identify the first input data and the second input data using the first artificial intelligence model 410 (e.g., the first artificial intelligence model 410 of FIG. 4A or 4B). The electronic device 200 may input the third user input and the history information to the first artificial intelligence model 410. The electronic device 200 may generate (or identify) the first input data and the second input data as an output of the first artificial intelligence model 410, based on inputting the third user input and the history information to the first artificial intelligence model 410.

The electronic device 200 may obtain third input data based on inputting the history information and the first input data to the first artificial intelligence model 410. The electronic device 200 may obtain the third input data, such as “Save a hiking schedule to Gwanggyo Mountain for next Wednesday morning at 7 a.m.”

The electronic device 200 may obtain fourth input data based on inputting the history information and the second input data to the first artificial intelligence model 410. The electronic device 200 may obtain the fourth input data, such as “Text Min-sung Kim ‘It takes 32 minutes to get to the Gwanggyo Mountain access road from 7:00 a.m. next Wednesday morning. Estimated arrival time is 7:32 a.m.’”

According to an embodiment, the operation on the third input data may be performed on a first domain. The operation on the fourth input data may be performed on a second domain.

For example, the electronic device 200 may first obtain the first response data for the third input data. The electronic device 200 may display an object 1332 and a user interface 1333 based on the first response data. The user interface 1333 may include an object 1341 for refusing to perform the operation according to the first response data and an object 1342 for accepting to perform the operation according to the first response data. For example, the first response data may include text for inquiring the user to store the schedule, and data for displaying a calendar application for storing the schedule.

According to an embodiment, the user of the electronic device 200 may not perform an input to the object 1341 and the object 1342. The electronic device 200 may identify an acceptance for performing the operation according to the first response data, by identifying a language-based user input (e.g., “Yes”). The electronic device 200 may display an object 1334 indicating the language-based user input. The electronic device 200 may display an object 1335 indicating that an operation according to the first response data (e.g., data for storing the user's Gwanggyo Mountain hiking schedule) has been performed.

The electronic device 200 may obtain the second response data (e.g., data for transmitting a text message about the Gwanggyo Mountain schedule to Min-sung Kim) to the fourth input data. The electronic device 200 may display an object 1336 and a user interface 1337, based on the second response data. For example, the electronic device 200 may display a user interface 1337 for inquiring about whether to perform an operation (e.g., adding the Gwanggyo Mountain hiking schedule) according to the second response data. For example, the electronic device 200 may display the user interface 1337 for inquiring about whether to add the Gwanggyo Mountain hiking schedule to the calendar application. For example, the user interface 1337 may include an object 1343 for refusing to perform the operation according to the second response data and an object 1344 for accepting to perform the operation according to the second response data.

The user of the electronic device 200 may perform an input to the object 1344. The electronic device 200 may display an object 1338 indicating that the operation according to the second response data has been performed. The electronic device 200 may display a user interface 1339 indicating a result of performing the operation according to the second response data. For example, the electronic device 200 may display the user interface 1339 indicating that a text has been transmitted to Min-sung Kim in order to indicate a result of performing the operation according to the second response data.

According to the above-described embodiment, an example in which the first response data is obtained prior to the second response data is illustrated, but the disclosure is not limited thereto. According to an embodiment, the second response data may be obtained prior to the first response data. When the second response data is obtained prior to the first response data, the electronic device 200 may display the object 1336 and the user interface 1337 and then display the object 1332 and the user interface 1333.

Although not shown herein, according to an embodiment, the electronic device 200 may display one object or user interface, based on the first response data and the second response data.

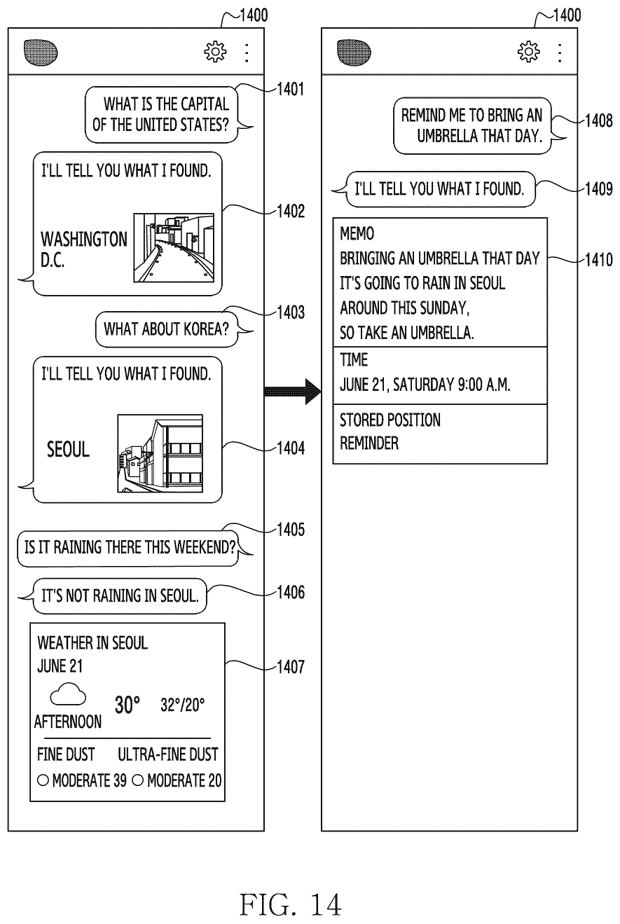

FIG. 14 illustrates an example of an operation of an electronic device according to an embodiment.

Referring to FIG. 14, the electronic device 200 may receive a first user input. The electronic device 200 may display an object 1401 representing the first user input on a user interface 1400 of the conversational application 463 (e.g., the conversational application 463 of FIG. 4A or 4B). The electronic device 200 may display an object 1402 representing a response to the first user input on the user interface 1400.

According to an embodiment, the electronic device 200 may receive a second user input. The electronic device 200 may display an object 1403 representing the second user input on the user interface 1400 of the conversational application 463. The electronic device 200 may change the second user input based on the history information. For example, the electronic device 200 may input the history information and the second user input to the first artificial intelligence model 410 (e.g., the first artificial intelligence model 410 of FIG. 4A or 4B). The electronic device 200 may generate (or obtain or identify) the changed second user input, based on inputting the history information and the second user input to the first artificial intelligence model 410. For example, the electronic device 200 may change “Korea is” to “Where is the capital of Korea” based on the history information about the conversation history. The electronic device 200 may obtain response data based on the changed second user input. For example, the electronic device 200 may obtain response data based on inputting the changed second user input to the third artificial intelligence model 440 (e.g., the third artificial intelligence model 440 of FIG. 4A or 4B). The electronic device 200 may display, on the user interface 1400, an object 1404 representing a response to the second user input. For example, the response data may cause the electronic device 200 to display the object 1404 for indicating the capital of Korea.

According to an embodiment, the electronic device 200 may receive a third user input. The electronic device 200 may display an object 1405 representing the third user input on the user interface 1400 of the conversational application 463. The electronic device 200 may change the third user input based on the history information. For example, the electronic device 200 may change “Is it raining there this weekend?” to “It rains this weekend in Seoul?” based on the history information on the conversation history. The electronic device 200 may obtain response data based on the changed third user input. The electronic device 200 may display, on the user interface 1400, an object 1406 and a user interface 1407 representing a response to the third user input, based on the response data.

The electronic device 200 may receive a fourth user input. The electronic device 200 may display an object 1408 representing the fourth user input on the user interface 1400 of the conversational application 463. The electronic device 200 may change the fourth user input based on the history information. For example, based on the history information on the conversation history, the electronic device 200 may change “Make a reminder to take an umbrella that day” to “Make a reminder to take an umbrella because it is going to rain in Seoul around Sunday.” The electronic device 200 may obtain response data based on the changed fourth user input. The electronic device 200 may display, on the user interface 1400, an object 1409 and a user interface 1410 representing a response to the fourth user input, based on the response data. For example, the response data may include text for indicating a response to the fourth user input and data for causing the electronic device 200 to register “Take an umbrella because it is going to rain in Seoul around Sunday” in the schedule application (or reminder application). The electronic device 200 may display “I'll tell you what I have searched” through the object 1409, based on the response data. The electronic device 200 may display a user interface 1410 related to the schedule application indicating that “Take an umbrella because it is going to rain around Sunday in Seoul” has been registered in the schedule application.

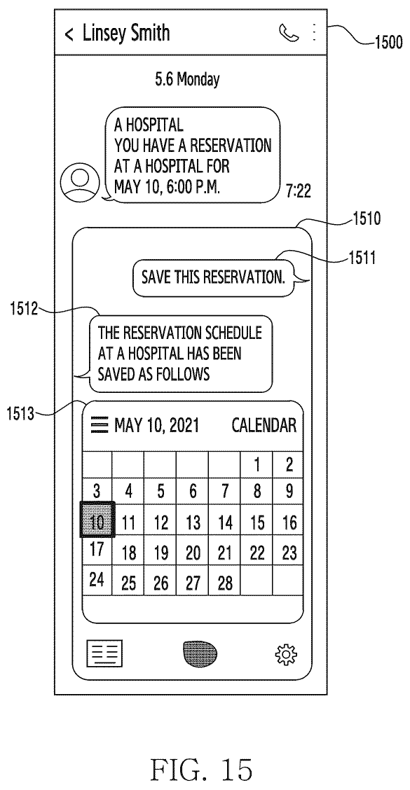

FIG. 15 illustrates an example of an operation of an electronic device according to an embodiment.

Referring to FIG. 15, the electronic device 200 may display a user interface 1500 of a first application while the first application (e.g., a message application) is being executed. The electronic device 200 may execute the conversational application 463 (e.g., the conversational application 463 of FIG. 4A or 4B), while the first application (e.g., the message application) is being executed. The electronic device 200 may display a user interface 1510 of the conversational application 463 by overlapping at least a part of the user interface 1500 of the first application (e.g., a message application).

According to an embodiment, the electronic device 200 may receive a user input using the conversational application 463. The electronic device 200 may display an object 1511 representing the user input on the user interface 1510.

According to an embodiment, the electronic device 200 may analyze a user input using an artificial intelligence model (e.g., the first artificial intelligence model 410 of FIG. 4A or 4B). The electronic device 200 may change an input value of the second application related to information (e.g., intent) according to the user input to execute the second application. For example, the electronic device 200 may identify a user input such as “Save this schedule.” The electronic device 200 may identify information displayed on the user interface 1500 of the first application which is currently being executed. The electronic device 200 may change the user input based on the identified information (e.g., the user's reservation information for A hospital). For example, the electronic device 200 may change “Save this schedule” to “Save the reservation schedule for A hospital at 6 p.m. on May 10”, using the first artificial intelligence model 410.

According to an embodiment, the electronic device 200 may obtain response data based on the changed user input. The electronic device 200 may display an object 1512 indicating that an operation according to the response data has been performed. The electronic device 200 may display a user interface 1513 of the second application (e.g., a calendar application) for providing a service according to the response data. For example, the user interface 1513 may display information on a result of performing the operation according to the response data.

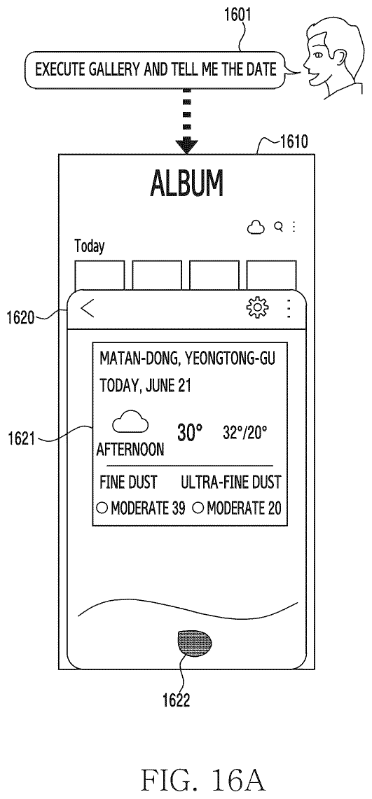

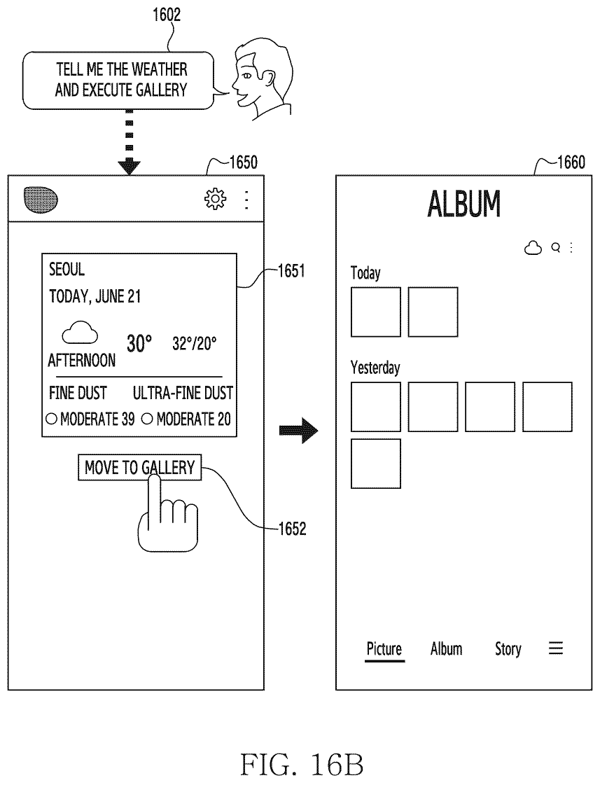

FIGS. 16A and 16B illustrate an example of an operation of an electronic device according to an embodiment.

Referring to FIG. 16A, the electronic device 200 may receive a user input 1601. The user input 1601 may be configured as “Execute the gallery and tell me the weather.” The electronic device 200 may identify the first input data and the second input data, based on the user input 1601. The electronic device 200 may identify the first input data, such as “Execute gallery.” The electronic device 200 may identify the second input data, such as “Tell me the weather.”

According to an embodiment, the electronic device 200 may obtain first response data (e.g., data causing execution of a gallery application), based on the first input data (e.g., “Execute gallery”). The electronic device 200 may execute the gallery application based on the first response data. The electronic device 200 may display a user interface 1610 of the gallery application. The electronic device 200 may obtain the second response data based on the second input data (e.g., “Tell me the weather”). The electronic device 200 may execute the conversational application 463 (e.g., the conversational application 463 of FIG. 4A or 4B), based on the second response data (e.g., data causing execution of the weather application to display the weather). The electronic device 200 may display a user interface 1620 of the conversational application 463. The electronic device 200 may display an object 1621 indicating weather information on the user interface 1620. For example, the user interface 1620 may include an object 1622 for receiving an additional user input.

Referring to FIG. 16A, an example in which the conversational application 463 is executed to display weather information is illustrated, but the disclosure is not limited thereto. According to an embodiment, a weather application may be executed to display the weather information.

Referring to FIG. 16B, the electronic device 200 may receive a user input 1602. The user input 1601 may be configured as “Tell me the weather and execute the gallery.” Based on the user input 1602, the electronic device 200 may identify first input data and second input data. The electronic device 200 may identify the first input data, such as “Tell me the weather.” The electronic device 200 may identify the second input data, such as “Execute the gallery”.

The electronic device 200 may obtain first response data, based on the first input data. The electronic device 200 may execute the conversational application 463, based on the first response data. The electronic device 200 may display a user interface 1650 of the conversational application 463. For example, the user interface 1650 may include an object 1651 for representing the weather information.

The electronic device 200 may obtain second response data based on the second input data. The electronic device 200 may display an object 1652 for executing a gallery application in the user interface 1650. The electronic device 200 may display a user interface 1660 of the gallery application, based on an input for the object 1652.

In FIG. 16B, an example in which the conversational application 463 is executed to display the weather information is illustrated, but the disclosure is not limited thereto. According to an embodiment, in order to display weather information, a weather application may be executed.

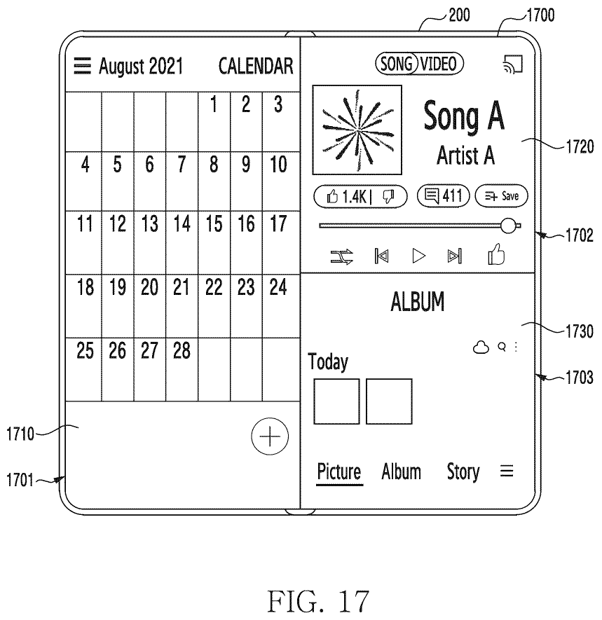

FIG. 17 illustrates an example of an operation of an electronic device according to an embodiment.

Referring to FIG. 17, the electronic device 200 may be a foldable electronic device. The electronic device 200 may identify a user input. For example, the user input may be “Show me a calendar, play music, and display an album”.

The electronic device 200 may identify three intents based on a user input. The electronic device 200 may identify a first intent for a first domain (e.g., a schedule management service), a second intent for a second domain (e.g., a music playback service), and a third intent for a third domain (e.g., a gallery execution service) based on a user input. The electronic device 200 may identify first input data including the first intent, second input data including the second intent, and third input data including the third intent based on a user input.

According to an embodiment, the electronic device 200 may identify the first input data requesting execution of the calendar application (e.g., execute (or display) a calendar application). The electronic device 200 may identify the second input data requesting execution of a music playback application (e.g., execute a music application (or play a music)). The electronic device 200 may identify the third input data requesting execution of a gallery application (e.g., execute (or display) a gallery application).

The electronic device 200 may obtain the first response data based on the first input data. The electronic device 200 may obtain the second response data based on the second input data. The electronic device 200 may obtain the third response data based on the third input data.

According to an embodiment, the display area 1700 of the electronic device 200 may be divided into a first display area 1701, a second display area 1702, and a third display area 1703. For example, in order to provide a service on the first domain, the electronic device 200 may display a first user interface 1710 of a first application (e.g., a calendar application) related to the first domain on the first display area 1701. In order to provide a service on the second domain, the electronic device 200 may display a second user interface 1720 of a second application related to the second domain on the second display area 1702. In order to provide a service on the third domain, the electronic device 200 may display a third user interface 1730 of a third application (e.g., a gallery application) related to the third domain on the third display area 1703.

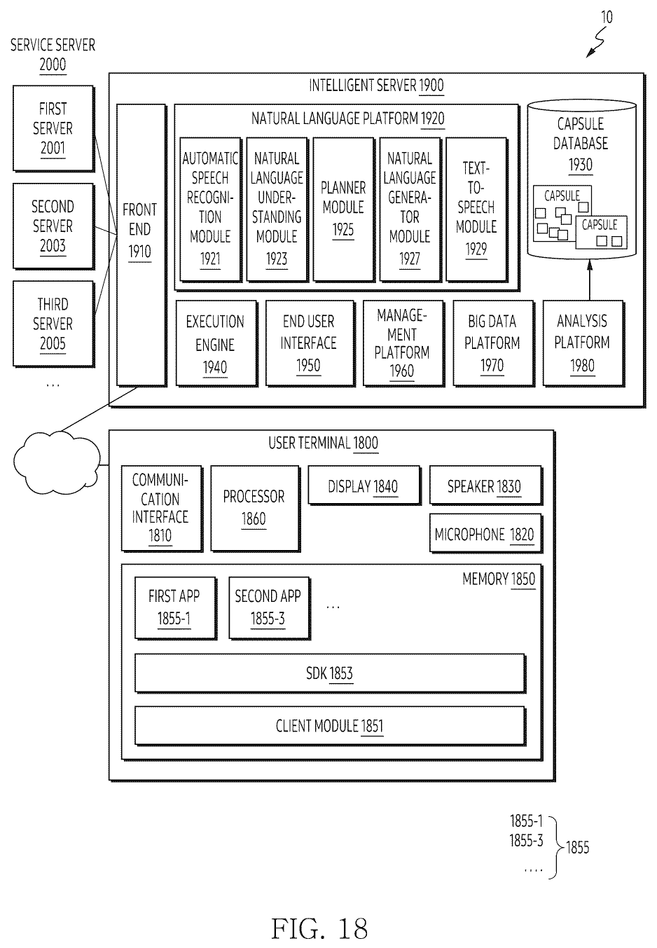

FIG. 18 is a block diagram illustrating an integrated intelligence system according to an embodiment.

Referring to FIG. 18, an integrated intelligence system 10 according to an embodiment may include a user terminal 1800, an intelligent server 1900, and a service server 2000.

The user terminal 1800 (e.g., electronic device 101 in FIG. 1) of an embodiment may be a terminal device (or electronic device) that may be connected to the Internet, and may be, for example, a mobile phone, a smartphone, a personal digital assistant (PDA), a laptop computer, a television, a domestic appliance, a wearable device, an HMD, or a smart speaker.

According to an embodiment, the user terminal 1800 may include a communication interface 1810, a microphone 1820, a speaker 1830, a display 1840, a memory 1850, and a processor 1860. These components enumerated above may be operatively or electrically connected to each other.

According to an embodiment, the communication interface 1810 may be configured to be connected to an external device to transmit and receive data. According to an embodiment, the microphone 1820 may receive a sound (e.g., a user utterance) and convert the sound into an electrical signal. According to an embodiment, the speaker 1830 may output an electrical signal as sound (e.g., voice). According to an embodiment, the display 1840 may be configured to display an image or video. According to an embodiment, the display 1840 may display a graphic user interface (GUI) of an app (or application program) to be executed.

The display 1840 according to an embodiment, may be configured to display an image or video. The display 1840 according to an embodiment may also display a graphic user interface (GUI) of an app (or application program) in execution. The display 1840 according to an embodiment may receive a touch input through a touch sensor. For example, the display 1840 may receive a text input via a touch sensor of an on-screen keyboard area displayed within the display 1840.

According to an embodiment, the memory 1850 may store a client module 1851, a software development kit (SDK) 1853, and a plurality of apps 1855. The client module 1851 and the SDK 1853 may configure a framework (or a solution program) for performing a universal function. Further, the client module 1851 or the SDK 1853 may configure a framework for processing user input (e.g., voice input, text input, or touch input).

According to an embodiment, the memory 1850 may be a program for performing a designated function of the plurality of apps 1855. According to an embodiment, the plurality of apps 1855 may include a first app 1855_1 and a second app 1855_3. According to an embodiment, each of the plurality of apps 1855 may include a plurality of operations for performing a designated function. For example, the plurality of apps 1855 may include at least one of an alarm app, a message app, and a schedule app. According to an embodiment, the plurality of apps 1855 may be executed by the processor 1860 to sequentially execute at least some of the plurality of operations.

According to an embodiment, the processor 1860 may control overall operations of the user terminal 1800. For example, the processor 1860 may be electrically connected to the communication interface 1810, the microphone 1820, the speaker 1830, the display 1840, and the memory 1850 to perform a designated operation.

According to an embodiment, the processor 1860 may also perform a designated function by executing a program stored in the memory 1850. For example, the processor 1860 may execute at least one of the client module 1851 and the SDK 1853 to perform the following operations for processing a user input. The processor 1860 may control the operations of a plurality of apps 1855 through the SDK 1853, for example. The following operations described as operations of the client module 1851 or the SDK 1853 may be operations by execution of the processor 1860.

According to an embodiment, the client module 1851 may receive a user input. For example, the client module 1851 may generate a voice signal corresponding to a user utterance detected through the microphone 1820. Alternatively, the client module 1851 may receive a touch input detected through the display 1840. Alternatively, the client module 1851 may receive a text input detected through a keyboard or an on-screen keyboard. In addition, it may receive various types of user inputs detected through an input module included in the user terminal 1800 or an input module connected to the user terminal 1800. The client module 1851 may transmit the received user input to the intelligent server 1900. According to an embodiment, the client module 1851 may transmit state information of the user terminal 1800 to the intelligent server 1900 together with the received user input. The state information may include, for example, execution state information of an app.

According to an embodiment, the client module 1851 may receive a result corresponding to the received user input. For example, the client module 1851 may receive the result corresponding to the user input from the intelligent server 1900. The client module 1851 may display the received result on the display 1840. Further, the client module 1851 may output the received result as audio via the speaker 1830.

According to an embodiment, the client module 1851 may receive a plan corresponding to the received user input. The client module 1851 may display a result of executing a plurality of operations of the app according to the plan on the display 1840. For example, the client module 1851 may sequentially display the execution result of the plurality of operations on the display and output audio through the speaker 1830. For another example, the user terminal 1800 may display only part of the result (e.g., a result of a last operation) of executing the plurality of operations on the display and output audio through the speaker 1830.

According to an embodiment, the client module 1851 may receive a request from the intelligent server 1900 to obtain information necessary to calculate a result corresponding to a user input. The information necessary to calculate the result may include, for example, state information of the user terminal 1800. According to an embodiment, the client module 1851 may transmit the necessary information to the intelligent server 1900 in response to the request.

According to an embodiment, the client module 1851 may transmit resultant information of executing the plurality of operations according to a plan to the intelligent server 1900. The intelligent server 1900 may confirm that the user input has been properly processed based on the resultant information.

According to an embodiment, the client module 1851 may include a voice recognition module. According to an embodiment, the client module 1851 may recognize a voice input that performs a limited function through the voice recognition module. For example, the client module 1851 may execute an intelligent app for processing a voice input for performing an organic operation through a designated input (e.g., wake-up!).

According to an embodiment, the intelligent server 1900 may receive information related to a user's voice input from the user terminal 1800 over a communication network. According to an embodiment, the intelligent server 1900 may change data related to the received voice input into text data. According to an embodiment, the intelligent server 1900 may generate a plan for performing a task corresponding to the user's voice input, based on the text data.

According to an embodiment, the plan may be generated by an artificial intelligence (AI) system. The artificial intelligence system may be a rule-based system, a neural network-based system (e.g., a feedforward neural network (FNN), or a recurrent natural network (RNN). Alternatively, it may be a combination of the aforementioned or a different artificial intelligence system. According to an embodiment, the plan may be selected from a set of predefined plans, or may be generated in real time in response to a user request. For example, the artificial intelligence system may select at least one plan from among a plurality of predefined plans.

According to an embodiment, the intelligent server 1900 may transmit a result obtained according to the generated plan to the user terminal 1800 or may transmit the generated plan to the user terminal 1800. According to an embodiment, the user terminal 1800 may display the result obtained according to the plan on a display. According to an embodiment, the user terminal 1800 may display a result of executing an operation according to the plan on the display.

The intelligent server 1900 according to an embodiment may include a front end 1910, a natural language platform 1920, a capsule database 1930, an execution engine 1940, an end user interface 1950, a management platform 1960, a big data platform 1970, and an analysis platform 1980.

According to an embodiment, the front end 1910 may receive a user input from the user terminal 1800. The front end 1910 may transmit a response corresponding to the user input.

According to an embodiment, the natural language platform 1920 may include an automatic speech recognition module (ASR module) 1921, a natural language understanding module (NLU module) 1923, a planner module 1925, a natural language generator module (NLG module) 1927, and a text-to-speech module (TTS module) 1929.

According to an embodiment, the automatic speech recognition module 1921 may convert a speech input received from the user terminal 1800 into text data. According to an embodiment, the natural language understanding module 1923 may use the text data of the speech input to grasp a user's intention. For example, the natural language understanding module 1923 may grasp the user's intention by performing syntactic analysis or semantic analysis for the user input in the form of text data. According to an embodiment, the natural language understanding module 1923 may recognize the meaning of a word extracted from a user input using a linguistic feature (e.g., syntactic element) of a morpheme or a phrase, and determine the intention of the user by matching the meaning of the recognized word to the intention. The natural language understanding module 1923 may obtain intent information corresponding to a user utterance. The intent information may include information indicating the user's intent determined by interpreting the text data. The intent information may include information indicating an operation or function that a user intends to execute using a corresponding device.

According to an embodiment, the planner module 1925 may generate a plan using the intent and parameters determined by the natural language understanding module 1923. According to an embodiment, the planner module 1925 may determine a plurality of domains required to perform a task based on the determined intent. The planner module 1925 may determine a plurality of operations included in each of the plurality of domains determined based on the intent. According to an embodiment, the planner module 1925 may determine a parameter required to execute the plurality of operations or a result value output by execution of the plurality of operations. The parameter and the result value may be defined as a concept related to a designated format (or class). Accordingly, the plan may include a plurality of operations and a plurality of concepts, determined by the user's intent. The planner module 1925 may determine a relationship between the plurality of operations and the plurality of concepts in a stepwise manner (or hierarchically). For example, the planner module 1925 may determine an execution order of the plurality of operations determined based on the user's intent, based on the plurality of concepts. In other words, the planner module 1925 may determine the execution order of the plurality of operations, based on the parameter required for execution of the plurality of operations and the result output by execution of the plurality of operations. Accordingly, the planner module 1925 may generate a plan including association information (e.g., ontology) between a plurality of operations and a plurality of concepts. The planner module 1925 may generate the plan using information stored in the capsule database 1930 in which a set of relationships between the concepts and the operations is stored.

According to an embodiment, the natural language generator module 1927 may change designated information into a text form. The information changed to the text form may be in the form of a natural language utterance. The text-to-speech module 1929 according to an embodiment may change information in the form of text into information in the form of voice.

According to an embodiment, the capsule database 1930 may store information on a relationship between a plurality of concepts and operations corresponding to a plurality of domains. For example, the capsule database 1930 may store a plurality of capsules including a plurality of action objects (or action information) and concept objects (or concept information) of the plan. According to an embodiment, the capsule database 1930 may store the plurality of capsules in the form of a concept action network (CAN). According to an embodiment, the plurality of capsules may be stored in a function register included in the capsule database 1930.

According to an embodiment, the capsule database 1930 may include a strategy registry in which strategic information is stored for determining a plan in response to a voice input. When there are a plurality of plans corresponding to a user input, the strategy information may include reference information for determining one plan. According to an embodiment, the capsule database 1930 may include a follow-up registry in which information of a follow-up operation for suggesting a follow-up operation to a user under a designated situation is stored. The follow-up operation may include, for example, a follow-up utterance. According to an embodiment, the capsule database 1930 may include a layout registry that stores layout information of information output through the user terminal 1800. According to an embodiment, the capsule database 1930 may include a vocabulary registry in which vocabulary information included in capsule information is stored. According to an embodiment, the capsule database 1930 may include a dialog registry in which dialog (or interaction) information with a user is stored.

According to an embodiment, the capsule database 1930 may update an object stored through a developer tool. The developer tool may include, for example, a function editor for updating an action object or a concept object. The developer tool may include a vocabulary editor for updating the vocabulary. The developer tool may include a strategy editor for generating and registering a strategy for determining a plan. The developer tool may include a dialog editor for generating a conversation with the user. The developer tool may include a follow-up action editor capable of activating a follow-up goal and editing a follow-up utterance providing a hint. The follow-up goal may be determined based on a currently set goal, a user's preference, or an environmental condition.

According to an embodiment, the capsule database 1930 may also be implemented in the user terminal 1800. In other words, the user terminal 1800 may include the capsule database 1930 to store information for determining an action corresponding to a voice input.

According to an embodiment, the execution engine 1940 may calculate a result using the generated plan. According to an embodiment, the end user interface 1950 may transmit the calculated result to the user terminal 1800. Accordingly, the user terminal 1800 may receive the result and provide the received result to the user. According to an embodiment, the management platform 1960 may manage information used in the intelligent server 1900. According to an embodiment, the big data platform 1970 may collect user data. According to an embodiment, the analysis platform 1980 may manage quality of service (QoS) of the intelligent server 1900. For example, the analysis platform 1980 may manage components and processing speeds (or efficiency) of the intelligent server 1900.

According to an embodiment, the service server 2000 may provide a designated service (e.g., food order or hotel reservation) to the user terminal 1800. According to an embodiment, the service server 2000 may be a server operated by a third party. For example, the service server 2000 may include a first service server 2001, a second service server 2003, and a third service server 2005 respectively operated by different third parties. According to an embodiment, the service server 2000 may provide information for generating a plan corresponding to the received voice input to the intelligent server 1900. The provided information may be stored, for example, in the capsule database 1930. Further, the service server 2000 may provide result information according to the plan to the intelligent server 1900.

In the integrated intelligence system described above, the user terminal 1800 may provide a user with various intelligent services in response to a user input. The user input may include, for example, an input through a physical button, a touch input, or a voice input.

According to an embodiment, the user terminal 1800 may provide a voice recognition service through an intelligent app (or a voice recognition app) stored therein. In such a case, for example, the user terminal 1800 may recognize a user utterance or voice input received through the microphone and provide the user with a service corresponding to the recognized voice input.

According to an embodiment, the user terminal 1800 may perform a designated operation alone or together with the intelligent server and/or the service server, based on the received voice input. For example, the user terminal 1800 may execute an app corresponding to the received voice input and perform a designated operation using the executed app.

According to an embodiment, when the user terminal 1800 provides a service together with the intelligent server 1900 and/or the service server, the user terminal may detect a user utterance using the microphone 1820 and generate a signal (or voice data) corresponding to the detected user utterance. The user terminal may transmit the voice data to the intelligent server 1900 using the communication interface 1810.

According to an embodiment, in response to the voice input received from the user terminal 1800, the intelligent server 1900 may generate a plan for performing a task corresponding to the voice input, or a result of performing an operation according to the plan. The plan may include, for example, a plurality of operations for performing a task corresponding to a user's voice input, and a plurality of concepts related to the plurality of operations. The concept may define a parameter that is input to the execution of the plurality of operations or a result value that is output by the execution of the plurality of operations. The plan may include association information between the plurality of operations and the plurality of concepts.

The user terminal 1800 according to an embodiment may receive the response using the communication interface 1810. The user terminal 1800 may output a voice signal generated inside the user terminal 1800 to the outside using the speaker 1830, or an image generated inside the user terminal 1800 to the outside using the display 1840.

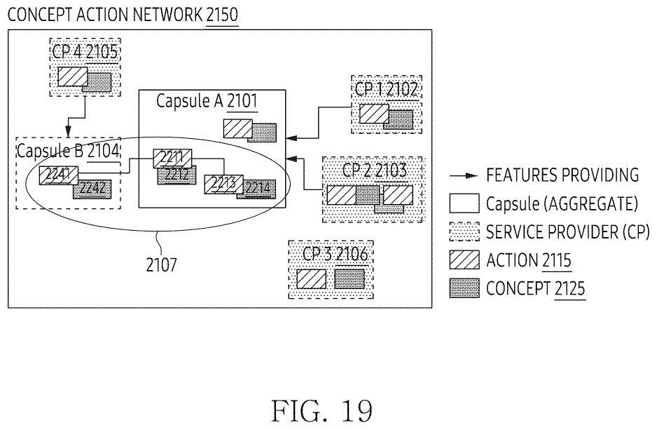

FIG. 19 is a diagram illustrating a form of relationship information between a concept and an operation stored in a database, according to various embodiments.

The capsule database (e.g., the capsule database 1930 of FIG. 18) of the intelligent server (e.g., the intelligent server 1900 of FIG. 18) may store a plurality of capsules in the form of a concept action network (CAN) 2150. The capsule database may store an action for processing a task corresponding to a user's voice input, and parameters necessary for the operation, in the form of the concept action network (CAN). The CAN may represent an organic relationship between an action and a concept defining a parameter necessary to perform the action.

The capsule database may store a plurality of capsules (e.g., capsule A (2101) and capsule B (2104)) corresponding to each of a plurality of domains (e.g., application). According to an embodiment, one capsule (e.g., capsule A (2101)) may correspond to one domain (e.g., application). In addition, one capsule may correspond to at least one service provider (e.g., CP 1 (2102), CP 2 (2103), CP 3 (2106), or CP 4 (2105)) for performing a function of a domain related to a capsule. According to an embodiment, one capsule may include at least one action 2115 and at least one concept 2125 for performing a designated function.

According to an embodiment, the natural language platform (e.g., the natural language platform 1920 of FIG. 18) may generate a plan to perform a task corresponding to a voice input received using a capsule stored in a capsule database. For example, the planner module 1925 of the natural language platform may generate the plan using the capsule stored in the capsule database. For example, the plan 2107 may be generated using the actions 2211 and 2213 and the concepts 2212 and 2242 of the capsule A 2101, and the operations 2241 and the concepts 2242 of the capsule B 2104.

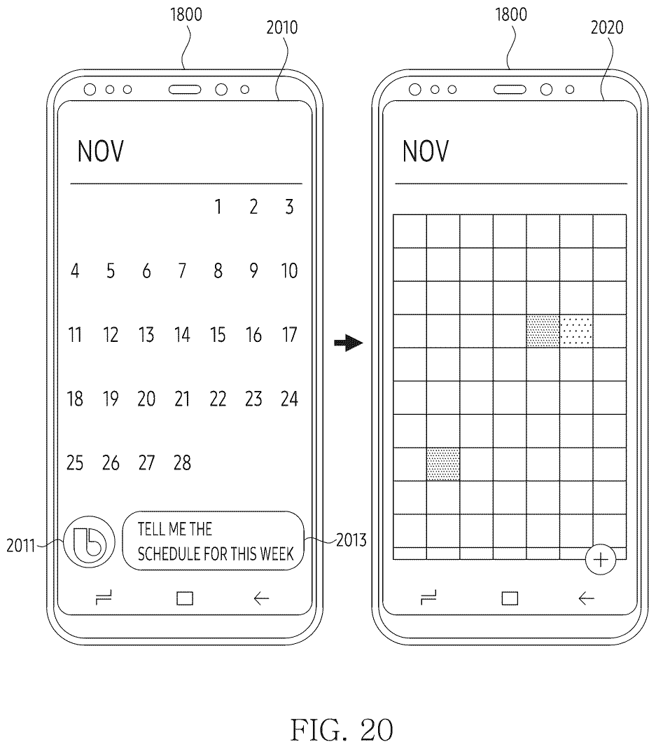

FIG. 20 is a diagram illustrating a screen in which a user terminal processes a voice input received through an intelligent app, according to various embodiments.

The user terminal 1800 may execute an intelligent app to process a user input through an intelligent server (e.g., the intelligent server 1900 of FIG. 13).

According to an embodiment, on a screen 2010, the user terminal 1800 may execute an intelligent app for processing a voice input, upon recognizing a designated voice input (e.g., Wake-up!) or receiving an input through a hardware key (e.g., a dedicated hardware key). The user terminal 1800 may execute, for example, the intelligent app, while executing the schedule app. According to an embodiment, the user terminal 1800 may display an object (e.g., icon) 2011 corresponding to the intelligent app on the display (e.g., the display 1840 of FIG. 18). According to an embodiment, the user terminal 1800 may receive a voice input by a user utterance. For example, the user terminal 1800 may receive a voice input of “Tell me this week's schedule!” According to an embodiment, the user terminal 1800 may display, on the display, a user interface (UI) 2013 (e.g., an input window) of the intelligent app on which text data of the received voice input is displayed.

According to an embodiment, on a screen 2020, the user terminal 1800 may display a result corresponding to the received voice input, on the display. For example, the user terminal 1800 may receive a plan corresponding to the received user input and display a ‘this week schedule’ on the display according to the plan.

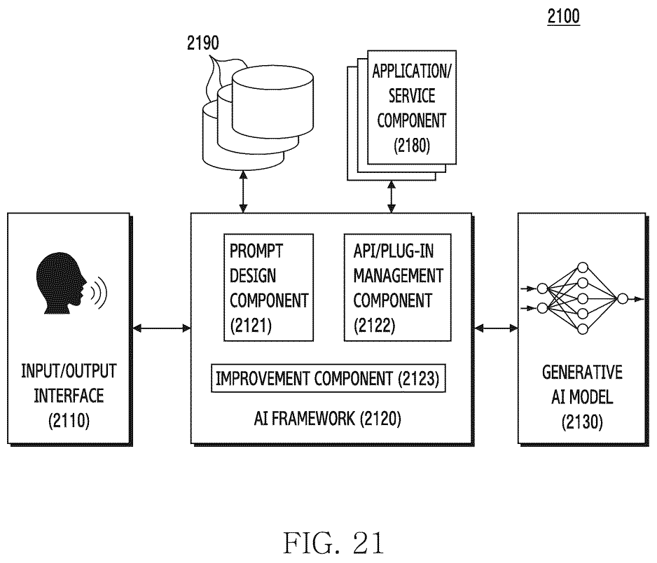

Some of the operations described above may be executed (or performed) through the artificial intelligence (AI) system described with reference to FIG. 21.

FIG. 21 is a schematic diagram of an example AI system.

Referring to FIG. 21, the AI system 2100 may include an input/output interface 2110, an AI framework 2120, a generative AI model 2130, and/or a knowledge storage 2190.

The input/output interface 2110 may receive an input. The input may include a user input and/or data obtained or generated by the electronic device. The data may include images generated by at least one processor of the electronic device, videos, and/or sensor data (e.g., as obtained from a sensor or a sensor hub (e.g., an auxiliary processor), inclusive of illumination data around the electronic device, posture data (or orientation data) of the electronic device, temperature inside the electronic device (e.g., temperature of the display or temperature of at least one processor), size information of the display area of the display, and/or an image obtained through an image sensor (e.g., included in the camera module) of the electronic device). The user input may include natural language, touch data obtained through a touch circuit included in the display module 160 (e.g., used to identify inputs from a finger and/or a stylus), an image displayed (and/or to be displayed) on the display module 160, and/or video. As a non-limiting example, the user input may be received via the input/output interface 2110 together with context information. The context information may be described as additional information obtained in relation to the user input. The context information may be related to a state when the user input is received (e.g., including a state of the electronic device and/or a state around the electronic device). For example, the context information may include information on one or more software applications executed in the electronic device when the user input is received. For example, the context information may include information on a location of the electronic device (or a user's location of the electronic device) when the user input is received. For example, the user input may be integrated with the context information. For example, the user input with the context information integrated thereto may be received by the input/output interface 2110.

The input/output interface 2110 may transmit (or provide) an output. The output may include a result (or result information) generated or obtained by the AI system 2100, based at least in part on the input. The format of the output may be various. For example, the output may include natural language. For example, the output may include content (e.g., including media content and/or multimedia content). For example, the output may include an action related to a user of the electronic device. For example, the output may have a format according to a user setting of the electronic device.

The input/output interface 2110 may be described as a user query/response interface 2110.

The AI framework 2120 may be used to obtain information (or data) about the input from the input/output interface 2110 and control one or more components related to the AI system 2100, using the obtained information.

For example, a prompt design component 2121 in the AI framework 2120 may generate or obtain a prompt for the generative AI model 2130 (e.g., including a large language model (LLM) or a large multimodal model (LMM)), using the obtained information. For example, the prompt design component 2121 may be described as an AI component that utilizes a learning algorithm and/or a neural network to provide an enhanced prompt over time. For example, the prompt design component 2121 may generate or obtain the prompt by accessing a knowledge component (e.g., the knowledge storage 2190) including user preference data, prompt library, and/or prompt examples using the obtained information. The generated prompt may be provided to the generative AI model 2130 (e.g., including LLM or LMM).

For example, an API/plug-in management component 2122 in the AI framework 2120 may be used to support communication for additional information requested (or caused) in connection with the prompt that is provided (or to be provided) to the generative AI model 2130. For example, the API/plug-in management component 2122 may be used to create or establish a channel for communication with various data sources (e.g., the knowledge storage 2190). For example, the API/plug-in management component 2122 may support access to at least some of the data sources. For example, the API/plug-in management component 2122 may be used to request another components (e.g., application/service component 2180) that performs feedback (or response) according to the prompt. As a non-limiting example, information obtained (or generated) through the API/plug-in management component 2122 may be provided to the prompt design component 2121 to generate the prompt. As a non-limiting example, the information obtained (or generated) through the API/plug-in management component 2122 may be provided to the generative AI model 2130.

For example, an improvement component 2123 in the AI framework 2120 may at least partially tune (or adjust, or change) a result (e.g., content) obtained (or output) from the generative AI model 2130. For example, the improvement component 2123 may determine or verify whether the content obtained from the generative AI model 2130 is related to the input. For example, the improvement component 2123 may determine or verify whether the content obtained from the generative AI model 2130 contains biased content. For example, the improvement component 2123 may determine or verify whether the content obtained from the generative AI model 2130 contains harmful content. For example, the improvement component 2123 may support or assist in performing additional processing to improve the content obtained from the generative AI model 2130. For example, the improvement component 2123 may, for example, support providing hints to the user to improve the content.

The generative AI model 2130 may be described as an artificial intelligence neural network that generates feedback in response to a prompt. For example, the feedback is related to the prompt, but may further include additional data and/or information relative to the prompt. For example, the feedback may include new content relative to the prompt. For example, the generative AI model 2130 may include a model for generating an image and/or a model for generating a language. For example, the model for generating an image may include a generative adversarial network (GAN) and/or a variational auto encoder (VAE). For example, the model for generating an image may include a diffusion-based generative model (e.g., transformer VAE). For example, the model for generating a language may include CHAT-GPT 3 and/or CHAT-GPT 4. For example, the generative AI model 2130 may include an LMM that recognizes text, image, and/or voice to generates the feedback.

As a non-limiting example, the AI framework 2120 and/or the generative AI model 2130 may be included in an AI module (e.g., including processing circuitry) in the electronic device. For example, the AI module may be operatively coupled to at least one processor of the electronic device. For example, the AI module may be operatively coupled to a display driving circuit of the electronic device. For example, the AI module may be operatively coupled to a sensor hub of the electronic device for one or more sensors in the electronic device.

According to an embodiment, an electronic device may include memory comprising one or more storage media, storing instructions, and at least one processor including processing circuitry, communicatively coupled to the memory. The instructions, when executed by the at least one processor individually or collectively, may cause the electronic device to: based on a language-based user input, identify first input data including first intent related to a first domain, and second input data including second intent related to a second domain; input the first input data to an application using one or more trained model; obtain, based on inputting the first input data to the application, first response data related to the first intent; generate, based on the first response data and the second input data, third input data; input the third input data to the application; based on inputting the third input data to the application, obtain second response data related to the second intent; and provide, based on the second response data, a service on the second domain, associated with a service on the first domain.

According to an embodiment, the instructions, when executed by the at least one processor individually or collectively, may cause the electronic device to identify the first input data including the first intent and the second input data including the second intent, based on inputting the language-based user input to a language-based first model.

According to an embodiment, the instructions, the first input data including the first intent and the second input data including the second intent may be identified based on inputting the language-based user input to a language-based first model.

According to an embodiment, the third input data may be generated based on inputting the first response data and the second input data to the language-based first model.

According to an embodiment, the instructions, when executed by the at least one processor individually or collectively, may cause the electronic device to, based on identifying that duration for obtaining the second response data is greater than threshold time, generate first output data according the first response data, and after the first output data is generated, generate second output data according to the second response data.

According to an embodiment, the electronic device may include a display. The instructions, when executed by the at least one processor individually or collectively, may cause the electronic device to, based on execution of a conversational application, display, via the display, a user interface of the conversational application, and while the user interface of the conversational application is displayed, obtain the language-based user input.

According to an embodiment, the instructions, when executed by the at least one processor individually or collectively, may cause the electronic device to display a first user interface of a first application related to the first domain for providing the service on the first domain based on the first response data, in the user interface of the conversational application, and display via the display a second user interface of a second application related to the second domain for providing the service on the second domain based on the second response data, in the user interface of the conversational application.

According to an embodiment, the instructions, when executed by the at least one processor individually or collectively, may cause the electronic device to, based on the first response data and the second response data, suspend display of the user interface of the conversational application, display, via the display, a first user interface of a first application related to the first domain, and display, via the display, a second user interface of a second application related to the second domain, superimposed on the first user interface.

According to an embodiment, the instructions, when executed by the at least one processor individually or collectively, may cause the electronic device to display at least one of a first object to execute a first application related to the first domain or a second object to execute a second application related to the second domain in the user interface of the conversational application.

According to an embodiment, the instructions, when executed by the at least one processor individually or collectively, may cause the electronic device to generate, based on the first response data and the second response data, output data related to the language-based user input, and display, in the user interface of the conversational application, a language-based response message according to the output data.

According to an embodiment, a method performed by the electronic device may include; based on a language-based user input, identifying first input data including first intent related to a first domain, and second input data including second intent related to a second domain; inputting the first input data to an application using one or more trained model; obtaining, based on inputting the first input data to the application, first response data related to the first intent; generating, based on the first response data and the second input data, third input data: inputting the third input data to the application; based on inputting the third input data to the application, obtaining second response data related to the second intent; and providing, based on the second response data, a service on the second domain, associated with a service on the first domain.

According to an embodiment, the first input data including the first intent and the second input data including the second intent may be identified based on inputting the language-based user input to a language-based first model.

According to an embodiment, the third input data may be generated based on inputting the first response data and the second response data to the language-based first model.

According to an embodiment, the method may include generating, based on inputting the first response data and the second response data to a language-based second model, output data related to the language-based user input.

According to an embodiment, the method may include, based on identifying that a duration for obtaining the second response data is greater than a threshold time, generating first output data according the first response data, and after the first output data is generated, generating second output data according to the second response data.

According to an embodiment, the method may include, based on execution of a conversational application, displaying, via a display of the electronic device, a user interface of the conversational application, and while the user interface of the conversational application is displayed, obtaining the language-based user input.

According to an embodiment, the method may include displaying a first user interface of a first application related to the first domain for providing the service on the first domain based on the first response data, in the user interface of the conversational application, and displaying a second user interface of a second application related to the second domain for providing the service on the second domain based on the second response data, in the user interface of the conversational application.

According to an embodiment, the method may include, based on the first response data and the second response data, suspending display of the user interface of the conversational application, displaying, via the display, a first user interface of a first application related to the first domain, and displaying, via the display, a second user interface of a second application related to the second domain, superimposed on the first user interface.

According to an embodiment, the method may include displaying at least one of a first object to execute the first application related to the first domain or a second object to execute the second application related to the second domain, in the user interface of the conversational application.

According to an embodiment, a non-transitory computer readable storage medium may store one or more programs. The one or more programs may include instructions that may, when executed by at least one processor of an electronic device, cause the electronic device to: based on a language-based user input, identify first input data including first intent related to a first domain, and second input data including second intent related to a second domain; input the first input data to the application; obtain, based on inputting the first input data to the application using one or more trained model, first response data related to the first intent; generate, based on the first response data and the second input data, third input data; input the third input data to the application; based on inputting the third input data to the application, obtain second response data related to the second intent; and provide, based on the second response data, a service on the second domain, associated with a service on the first domain.

According to an embodiment, an electronic device may include memory including one or more storage media, storing instructions, and at least one processor comprising processing circuitry. The instructions, when executed by the at least one processor individually or collectively, may cause the electronic device to: based on inputting a user input to a first artificial intelligence (AI) model, identify first input data including first intent and second input data including second intent; input the first input data to a third AI model, obtain, based on inputting the first input data to the third AI model, first response data related to the first intent, generate, based on inputting the first response data and the second input data to a first AI model, third input data, input the third input data to the third AI model, based on inputting the third input data to the third AI model, obtain second response data related to the second intent, based on inputting the first response data and the second response data to a second AI model, obtain output data, and provide the output data to a user related to the electronic device.

According to the above-described embodiment, an artificial intelligence model based on a rule model and a deep model may be difficult to process a user input of the multi-turn and multi-intent. Thus, the use of a generative model has the effect that the processing of complex utterances by the user can be performed by the electronic device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment, the electronic devices are not limited to those described above.

It should be appreciated that various embodiments and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may be interchangeably used with other terms, for example, ‘logic’, ‘logic block’, ‘component’, ‘part’, ‘portion’, or ‘circuit’. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments disclosed herein may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the scope of the disclosure as defined by the appended claims and their equivalents.

What is claimed is:

1. An electronic device, comprising:
memory comprising one or more storage media, storing instructions; and
at least one processor comprising processing circuitry, communicatively coupled to the memory,
wherein the instructions, when executed by the at least one processor individually or collectively, cause the electronic device to:
based on a language-based user input, identify first input data including first intent related to a first domain and second input data including second intent related to a second domain,
input the first input data to an application using one or more trained models,
obtain, based on inputting the first input data to the application, first response data related to the first intent,
generate, based on the first response data and the second input data, third input data,
input the third input data to the application,
based on inputting the third input data to the application, obtain second response data related to the second intent, and
provide, based on the second response data, a service on the second domain associated with a service on the first domain.

2. The electronic device of claim 1, wherein the first input data including the first intent and the second input data including the second intent are identified based on inputting the language-based user input to a language-based first model.

3. The electronic device of claim 2, wherein the third input data is generated based on inputting the first response data and the second response data to the language-based first model.

4. The electronic device of claim 2, wherein the instructions, when executed by the at least one processor individually or collectively, cause the electronic device to generate, based on inputting the first response data and the second response data to a language-based second model, output data related to the language-based user input.

5. The electronic device of claim 1, wherein the instructions, when executed by the at least one processor individually or collectively, cause the electronic device to:
based on identifying that duration for obtaining the second response data is greater than threshold time, generate first output data according the first response data, and
after the first output data is generated, generate second output data according to the second response data.

6. The electronic device of claim 1,
wherein the electronic device comprises a display, and
wherein the instructions, when executed by the at least one processor individually or collectively, cause the electronic device to:
based on execution of a conversational application, display, via the display, a user interface of the conversational application, and
while the user interface of the conversational application is displayed, obtain the language-based user input.

7. The electronic device of claim 6, wherein the instructions, when executed by the at least one processor individually or collectively, cause the electronic device to:
display a first user interface of a first application related to the first domain for providing the service on the first domain based on the first response data, in the user interface of the conversational application, and
display a second user interface of a second application related to the second domain for providing the service on the second domain based on the second response data, in the user interface of the conversational application.

8. The electronic device of claim 6, wherein the instructions, when executed by the at least one processor individually or collectively, cause the electronic device to:
based on the first response data and the second response data:
suspend display of the user interface of the conversational application,
display, via the display, a first user interface of a first application related to the first domain, and
display, via the display, a second user interface of a second application related to the second domain superimposed on the first user interface.

9. The electronic device of claim 6, wherein the instructions, when executed by the at least one processor individually or collectively, cause the electronic device to display at least one of a first object to execute a first application related to the first domain or a second object to execute a second application related to the second domain in the user interface of the conversational application.

10. The electronic device of claim 6, wherein the instructions, when executed by the at least one processor individually or collectively, cause the electronic device to:
generate, based on the first response data and the second response data, output data related to the language-based user input, and
display, in the user interface of the conversational application, a language-based response message according to the output data.

11. A method performed by an electronic device, the method comprising:
based on a language-based user input, identifying first input data including first intent related to a first domain and second input data including second intent related to a second domain;
inputting the first input data to an application using one or more trained models;
obtaining, based on inputting the first input data to the application, first response data related to the first intent;
generating, based on the first response data and the second input data, third input data;
inputting, the third input data to the application;
based on inputting the third input data to the application, obtaining second response data related to the second intent; and
providing, based on the second response data, a service on the second domain associated with a service on the first domain.

12. The method of claim 11, wherein the first input data including the first intent and the second input data including the second intent are identified based on inputting the language-based user input to a language-based first model.

13. The method of claim 12, wherein the third input data is generated based on inputting the first response data and the second response data to the language-based first model.

14. The method of claim 12, wherein the method comprises generating, based on inputting the first response data and the second response data to a language-based second model, output data related to the language-based user input.

15. The method of claim 11, wherein the method comprises:
based on identifying that duration for obtaining the second response data is greater than threshold time, generating first output data according the first response data; and
after the first output data is generated, generating second output data according to the second response data.

16. The method of claim 11, wherein the method comprises:
based on execution of a conversational application, displaying, via a display of the electronic device, a user interface of the conversational application; and
while the user interface of the conversational application is displayed, obtaining the language-based user input.

17. The method of claim 16, wherein the method comprises:
displaying a first user interface of a first application related to the first domain for providing the service on the first domain based on the first response data, in the user interface of the conversational application; and
displaying a second user interface of a second application related to the second domain for providing the service on the second domain based on the second response data, in the user interface of the conversational application.

18. The method of claim 16, wherein the method comprises:
based on the first response data and the second response data:
suspending display of the user interface of the conversational application;
displaying, via the display, a first user interface of a first application related to the first domain; and
displaying, via the display, a second user interface of a second application related to the second domain superimposed on the first user interface.

19. The method of claim 16, wherein the method comprises displaying at least one of a first object to execute a first application related to the first domain or a second object to execute a second application related to the second domain in the user interface of the conversational application.

20. A non-transitory computer readable storage medium storing one or more programs, wherein the one or more programs comprise instructions that, when executed by at least one processor of an electronic device, cause the electronic device to:
based on a language-based user input, identify first input data including first intent related to a first domain, and second input data including second intent related to a second domain,
input the first input data to an application,
obtain, based on inputting the first input data to the application using one or more trained model, first response data related to the first intent,
generate, based on the first response data and the second input data, third input data,
input the third input data to the application,
based on inputting the third input data to the application, obtain second response data related to the second intent, and
provide, based on the second response data, a service on the second domain, associated with a service on the first domain.
